(19) United States
(12) Patent Application Publication
(10) Pub. No.: US 2006/0040327 A1
(43) Pub. Date: Feb. 23, 2006

(54) Methods of screening proteins

(76) Inventors: Terry Amiss, Cary, NC (US); Eileen Snowden, Cary, NC (US); James Bruce Pitner, Durham, NC (US)

Correspondence Address: DAVID W. HIGHET;BECTON, DICKINSON AND COMPANY, 1 BECTON DRIVE, MC110, FRANKLIN LAKES, NJ, 07417, US

(21) Appl. No.: 11/205,740

(22) Filed: Aug. 17, 2005

Related U.S. Application Data
(60) Provisional application No. 60/606,504, filed on Sep. 2, 2004.
(60) Provisional application No. 60/602,340, filed on Aug. 18, 2004.

(51) Int. Cl. C40B 40/10; C40B 50/06

(52) U.S. Cl. 435/7.1

(57) ABSTRACT

The present invention relates to methods of screening or isolating stable mutant binding proteins from a protein library of mutant proteins. The methods comprise culturing host cells under conditions suitable for protein expression. The collection of host cells comprise collectively a set of expression vectors, and this collection of expression vectors encodes the various members of a protein library of mutant binding proteins. The cultured cells, harboring the expression vectors, are contacted with a ligand, and differences in interaction, among the individual host cells, with the ligand are detected. The individual host cells displaying the desired interaction with the ligand are then separated from individual host cells that do not display the desired interaction with the ligand.

### CROSS-REFERENCE TO RELATED APPLICATIONS

The application claims priority to U.S. Provisional Application Nos. 60/606,504, filed Sep. 2, 2004 and 60/602,340, filed Aug. 18, 2004, both of which are incorporated by reference in their entirety.

### BACKGROUND OF THE INVENTION

1. Field of the Invention

The present invention relates to methods of screening or isolating stable mutant binding proteins from a protein library of mutant proteins. The methods comprise culturing host cells under conditions suitable for protein expression. The collection of host cells comprises collectively a set of expression vectors, and this collection of expression vectors encodes the various members of a protein library of mutant binding proteins. The cultured cells, harboring the expression vectors, are contacted with a ligand, and differences in interaction, among the individual host cells, with the ligand are detected. The individual host cells displaying the desired interaction with the ligand are then separated from individual host cells that do not display the desired interaction with the ligand.

2. Background of the Invention

A rapidly advancing area of biosensor development is the use of binding proteins, such as periplasmic binding proteins (PBPs). It is believed that most PBP's, upon binding of a ligand, undergo conformational changes as the binding pocket of the proteins' binding sites close around the ligand. As a result of these conformational changes, portions of the protein may experience changes in their microenvironment. These changes in the PBP's microenvironment upon binding have been exploited for use as biosensors.

Computational methods have been devised to predict which sites within candidate wild-type binding proteins can be mutated to “customize” the binding selectivity and affinity of the binding proteins. In general, however, proteins are marginally stable and mutation of one or more amino acids may “create” an unstable protein that is non-functional due to unfolding. While computational methods are used to predict which amino acids can be mutated to alter a protein's binding characteristics, to date it has not been possible to screen the stability of the mutant protein. In fact, computationally designed proteins have been reported as having stability problems. See Sterner, R. and Schmid, F. Science, 304: 1916-1917 (2004) and Dwyer, M., et al., Science, 304: 1967-1971 (2004). These computationally modeled proteins, when expressed and purified in the laboratory, are often unstable and, if even viable, may only function in a properly folded state for a very short time.

In contrast, binding proteins isolated from large mutant protein libraries are generally stable in that they were able to exist in an intracellular environment long enough for detection and selection at ambient temperature (37° C.). Small protein libraries composed of 10³-10⁵ distinct mutants can be screened by first growing each clone separately and then using a conventional assay for detecting clones that exhibit specific binding. For example, individual clones expressing different protein mutants can be grown in microtiter well plates or separate colonies on semisolid media such as agar plates. To detect binding, the cells are lysed to release the proteins and the lysates are transferred to nylon filters, which are then probed using radiolabeled or fluorescently labeled ligands (De Wildt et al., Nat. Biotechnol. 18: 989 (2000)). However, even with robotic automation and digital image systems for detecting binding in high density arrays, it is not feasible to screen large libraries consisting of tens of millions or billions of clones. The screening of libraries of that size, however, may be required for the de novo isolation of binding proteins that have affinities in a specific physiological range suitable, for example, as biosensors.

The screening of very large protein libraries has been accomplished by a variety of techniques that rely on the display of proteins on the surface of viruses or cells (Ladner et al., Gene (1993) 128(1):29-36). The underlying premise of display technologies is that proteins engineered to be anchored on the external surface of biological particles, i.e., cells or viruses are directly accessible for binding to ligands without the need for lysing the cells.

The most widely used display technology for protein library screening applications is phage display. Phage display is a well-established and powerful technique for the discovery of proteins that bind to specific ligands and for the engineering of binding affinity and specificity (Rodi and Makowski, Curr. Opin. Biotechnol., 10: 87-93, (1999)). In phage display, a gene of interest is fused in-frame to phage genes encoding surface-exposed proteins, most commonly pIII. The gene fusions are translated into chimeric proteins in which the two domains fold independently. Protein libraries have also been displayed on the surface of bacteria, fungi, or higher cells. Cell displayed libraries are typically screened by flow cytometry (US Published Application 2004/0058503 and Georgiou et al., Nat. Biotechnol. 15:29, (1997), Daugherty et al., J. Immunol. Methods. 243:211, (2000)). However, the screening of phage-displayed libraries can be complicated. First, phage display imposes minimal selection for proper expression in bacteria by virtue of the low expression levels of antibody fragment gene III fusion necessary to allow phage assembly and yet sustain cell growth (Krebber, et al., J. Immunol. Methods. 201, 35-55 (1997)). As a result, the clones isolated after several rounds of panning are frequently difficult to produce on a preparative scale in E. coli. Second, although phage displayed proteins may bind a ligand, in some cases their un-fused soluble counterparts may not (Griep et al., Prot. Exp. Purif., 16:63, (1999)). Third, the isolation of ligand-binding proteins and more specifically antibodies having high binding affinities can be complicated by avidity effects by virtue of the need for gene III protein to be present at around 5 copies per virion to complete phage assembly. Even with systems that result in predominantly monovalent protein display, there is nearly always a small fraction of clones that contain multiple copies of the protein. Such clones bind to the immobilized surface more tightly and are enriched relative to monovalent phage with higher affinities (Deng et al., Proc. Natl. Acad. Sci. USA. 92:4992, (1995); MacKenzie et al., J. Immunol. Methods, 220:39, (1998); MacKenzie et al., J. Biol. Chem., 271:1527, (1996)). Fourth, panning is still a “black box” process in that the effects of experimental conditions, for example the stringency of washing steps to remove weakly or non-specifically bound phage, can only be determined by trial and error based on the final outcome of the experiment. Fifth, even though pIII and, to a lesser extent, the other proteins of the phage coat are generally tolerant to the fusion of heterologous polypeptides, the need to be incorporated into the phage biogenesis process imposes biological constraints that can limit library diversity. Finally, where the goal is to create libraries of proteins with lower affinity or altered specificity, the proteins may not lend themselves to binding of labeled ligands that would afford isolation or concentration of the clone.

Another method of screening large libraries involves cloning a nucleic acid sequence encoding a candidate binding polypeptide and isolating and concentrating the bacterium expressing the protein. (WO 02/34886 to Chen et al.,) By contacting the bacterium with a labeled ligand capable of diffusing into the bacterium's periplasm, selection of specific bacterium is provided by the binding of the labeled ligand bound to the candidate binding polypeptides. Included in these methods is periplasmic expression of antibody fragments with cytometric screening (PECS) (Chen et al., Nature Biotechnology (2001) 19:537-42). The methods of Chen et al. were applied to antibody fragments that irreversibly bind their ligand/antigen. In addition to not addressing proteins that reversibly bind their target ligands, the PECS method requires that the ligand be labeled. Accordingly, these methods are not the most reliable methods for assessing true binding affinity of the mutant protein towards the ligand of choice, because of changes in ligand properties due to dye-labeling and rapid receptor-ligand binding kinetics that prevent binding analysis.

Therefore, there is a need in the art for rapidly screening large libraries of mutant periplasmic binding proteins to identify and isolate stable mutant binding proteins capable of specifically binding a ligand of choice, with desired binding characteristics.

### SUMMARY OF THE INVENTION

The present invention relates to methods of screening or isolating stable mutant binding proteins from a protein library of mutant proteins. The methods comprise culturing host cells under conditions suitable for protein expression. The collection of host cells comprises collectively a set of expression vectors, and this collection of expression vectors encodes the various members of a protein library of mutant binding proteins. The cultured cells, harboring the expression vectors, are contacted with a ligand, and differences in interaction, among the individual host cells, with the ligand are detected. The individual host cells displaying the desired interaction with the ligand are then separated from individual host cells that do not display the desired interaction with the ligand.

The present invention also relates to methods of isolating polynucleotides that encode mutant proteins. The methods comprise culturing host cells under conditions suitable for protein expression. The collection of host cells comprise collectively a set of expression vectors, and this collection of expression vectors encodes the various members of a protein library of mutant binding proteins. The cultured cells, harboring the expression vectors, are contacted with a ligand, and differences in interaction, among the individual host cells, with the ligand are detected. The individual host cells displaying the desired interaction with the ligand are then separated from individual host cells that do not display the desired interaction with the ligand. Once the cells are separated, the expression vectors within the host cells that display the desired interaction with the ligand are isolated from the appropriate host cells.

The present invention also relates to methods of generating stable mutant binding proteins. The methods comprise culturing host cells under conditions suitable for protein expression. The collection of host cells comprises collectively a set of expression vectors, and this collection of expression vectors encodes the various members of a protein library of mutant binding proteins. The cultured cells, harboring the expression vectors, are contacted with a ligand, and differences in interaction, among the individual host cells, with the ligand are detected. The individual host cells displaying the desired interaction with the ligand are then separated from individual host cells that do not display the desired interaction with the ligand. Once the cells are separated, the expression vectors within the host cells that display the desired interaction with the ligand are isolated from the appropriate host cells. The portion of the expression vectors comprising the polynucleotides encoding the mutant binding proteins is then subjected to further rounds of targeted random mutagenesis to prepare subsequent mutant protein libraries. These subsequent mutant protein libraries are then subjected to an additional round of screening and isolation. This process of generating and regenerating subsequent mutant protein libraries and can be repeated as necessary until a mutant protein possessing the desired properties is obtained.

### BRIEF DESCRIPTION OF THE DRAWINGS

FIG. 1 depicts enrichment of host cells expressing mutant periplasmic binding protein by screening of binding to a fluorescent ligand using FACS.

FIG. 2 depicts a plot of the CD spectra ellipticity at 220 nm wavelength of a fluorescently labeled periplasmic binding protein versus temperature. The plot for the protein without ligand is the solid line and the dotted line is the same protein in the presence of its ligand (glucose).

### DETAILED DESCRIPTION OF THE INVENTION

The present invention relates to methods of screening, identifying and isolating stable mutant binding proteins from a protein library of mutant proteins. As used herein, the term “identify,” as it relates to molecules, is used to mean that differences in characteristics of the molecules are recognized. Thus, “identify” is not intended to be so specific as to only mean that the exact formula or structure of the identified molecule is known. Rather, a molecule is identified herein based upon its physical characteristics. The present invention also relates to methods of isolating polynucleotides that encode mutant proteins. As used herein, a molecule is “isolated” when the molecule is separated from its normal environment or when the more immediate environment, such as but not limited to a host cell or synthetic matrix, surrounding or harboring the desired molecule is separated from other similar immediate environments. Thus, while “isolated” can mean that the molecule is purified, either partially or substantially, from a cell or tissue; and “isolated” is also used to mean that the more immediate environment harboring the molecule, e.g., a host cell, is or can be readily separated from other cells.

The methods of the current invention relate to isolating stable mutant binding proteins. As used herein, “stable” is used to mean that the mutant proteins do not unfold or become inactivated at temperatures from about 15° C. to about 50° C. The length of stability, may last as little as 1 hour or less after expression, or it may last 6 months or longer. In one embodiment, the mutant proteins are “stable” at temperatures from about 20° C. to about 42° C. Unstable proteins will, in general, unfold more quickly than stable proteins, and, once unfolded, unstable proteins are then subject to inactivation through such processes as aggregation, disulphide exchange, proteolysis, irreversible subunit dissociation and chemical degradation. Additionally, unfolded proteins, even if not “inactivated,” will generally not bind any ligand. Accordingly, a “stable” molecule, e.g., a protein, as used herein, is a protein that is not readily or quickly inactivated at temperatures of about 15° C. to about 50° C., such that ligand binding, if possible, is detectable. The term “stable” is not synonymous with the ability of the protein to bind a ligand, thus a protein may not be able to bind a ligand to any detectable extent, but still be considered stable. Thus, assessing the ability of the mutant protein to bind a ligand at temperatures from about 15° C. to about 50° C. will serve to test the stability of the protein, as well as the ability of the mutant protein to bind to the ligand.

The “binding proteins” upon which the mutant protein libraries of the present invention are based are proteins that specifically bind one or more ligands, prior to their mutation. The binding proteins may or may not be made up entirely of amino acids. Examples of classes of binding proteins that include other non amino acid constituents include, but are not limited to, glycoproteins, lipoprotiens and proteoglycans. As used herein, the terms “protein” and “polypeptide” are used interchangeably. Examples of binding proteins upon which the mutant protein libraries may be based include, but are not limited to, antibodies or functional antibody fragments, enzymes or functional fragments thereof, and periplasmic binding proteins (PBPs) or functional fragments thereof. The methods of the present invention can be applied to binding proteins, regardless of their binding kinetics towards the ligand, i.e., reversibility or irreversibility of binding of the mutant binding proteins towards the ligand. For example, the k_{off} for the expressed antibodies (scFvs) has been reported as about ˜2×10⁻⁴ s⁻¹, whereas the k_{off} for wild type periplasmic binding protein maltose binding protein (MBP) towards maltose is about 90 s⁻¹ and towards maltotriose is about 8.4 s⁻¹. Functional antibody fragments include chemically derived antibody fragments, such as Fab, Fab′ or F(ab′)₂ fragments, or fragments produced through recombinant means, such as, for example, molecules comprising scFv fragments, including but not limited to, scFv tetramers.

As used herein a PBP is a protein characterized by its three-dimensional configuration (tertiary structure), rather than its amino acid sequence (primary structure) and is characterized by a lobe-hinge-lobe region. The PBP will normally bind an analyte specifically in a cleft region between the lobes of the PBP. Furthermore, the binding of an analyte in the cleft region will then cause a conformational change to the PBP that makes detection of the analyte possible. Periplasmic binding proteins of the current invention include any protein that possesses the structural characteristics described herein; and analyzing the three-dimensional structure of a protein to determine the characteristic lobe-hinge-lobe structure of the PBPs is well within the capabilities of one of ordinary skill in the art. Examples of PBPs include, but are not limited to, glucose-galactose binding protein (GGBP), maltose binding protein (MBP), ribose binding protein (RBP), arabinose binding protein (ABP), dipeptide binding protein (DPBP), glutamate binding protein (GluBP), iron binding protein (FeBP), histidine binding protein (HBP), phosphate binding protein (PhosBP), glutamine binding protein (QBP), oligopeptide binding protein (OppA), or derivatives thereof, as well as other proteins that belong to the families of proteins known as periplasmic binding protein like I (PBP-like I) and periplasmic binding protein like II (PBP-like II). The PBP-like I and PBP-like II proteins have two similar lobe domains comprised of parallel β-sheets and adjacent a helices. The glucose-galactose binding protein (GGBP) belongs to the PBP-like I family of proteins, whereas the maltose binding protein (MBP) belongs to the PBP-like II family of proteins. The ribose binding protein (RBP) is also a member of the PBP family of proteins. Other non-limiting examples of periplasmic binding proteins are listed in Table I.

TABLE I
Genes Encoding Common Periplasmic Binding Proteins

| Gene name | Substrate | Species |
|---|---|---|
| alsB | Allose | E. coli |
| araF | Arabinose | E. coli |
| AraS | Arabinose/fructose/xylose | S. solfataricus |
| argT | Lysine/arginine/ornithine | Salmonella typhimurium |
| artl | Arginine | E. coli |
| artJ | Arginine | E. coli |
| b1310 | Unknown | E. coli |
| | (putative, multiple sugar) | |
| b1487 | Unknown (putative, | E. coli |
| | oligopeptide binding) | |
| b1516 | Unknown (sugar binding | E. coli |
| | protein homolog) | |
| butE | vitamin B12 | E. coli |
| CAC1474 | Proline/glycine/betaine | Clostridium acetobutylicum |
| cbt | Dicarboxylate (Succinate, | E. coli |
| | malate, fumarate) | |
| CbtA | Cellobiose | S. solfataricus |
| chvE | Sugar | A. tumefaciens |
| CysP | Thiosulfate | E. coli |
| dctP | C4-dicarboxylate | Rhodobacter capsulatus |
| dppA | Dipeptide | E. coli |
| FbpA | Iron | Neisseria gonorrhoeae |
| fecB | Fe(III)-dicitrate | E. coli |
| fepB | enterobactin-Fe | E. coli |
| fhuD | Ferrichydroxamate | E. coli |
| FliY | Cystine | E. coli |
| GlcS | glucose/galactose/mannose | S. solfataricus |
| glnH | Gluconate | E. coli |
| (protein: | | |
| GLNBP) | | |
| gntX | Gluconate | E. coli |
| hemT | Haemin | Y. enterocolitica |
| HisJ | Histidine | E. coli |
| (protein: | | |
| HBP) | | |
| hitA | Iron | Haemophilus influenzae |
| livJ | Leucine/valine/isoleucine | E. coli |
| livK | Leucine | E. coli |
| (protein: | | |
| L-BP | | |
| malE | maltodextrin/maltose | E. coli |
| (protein: | | |
| MBP) | | |
| mglB | glucose/galactose | E. coli |
| (protein: | | |
| GGBP) | | |
| modA | Molybdate | E. coli |
| MppA | L-alanyl-gamma-D-glutamyl- | E. coli |
| | meso-diaminopimelate | |
| nasF | nitrate/nitrite | Klebsiella oxytoca |
| nikA | Nickel | E. coli |
| opBC | Choline | B. Subtilis |
| OppA | Oligopeptide | Salmonella typhimurium |
| PhnD | Alkylphosphonate | E. coli |
| PhoS | Phosphate | E. coli |
| (Psts) | | |
| potD | putrescine/spermidine | E. coli |
| potF | Polyamines | E. coli |
| proX | Betaine | E. coli |
| rbsB | Ribose | E. coli |
| SapA | Peptides | S. typhimurium |
| sbp | Sulfate | Salmonella typhimurium |
| TauA | Taurin | E. coli |
| TbpA | Thiamin | E. coli |
| tctC | Tricarboxylate | Salmonella typhimurium |
| TreS | Trehalose | S. solfataricus |
| tTroA | Zinc | Treponema pallidum |
| UgpB | sn-glycerol-3-phosphate | E. coli |
| XylF | Xylose | E. coli |
| YaeC | Unknown | E. coli |
| | (putative) | |
| YbeJ | glutamate/aspartate | E. coli |
| (Gltl) | (putative, superfamily: | |
| | lysine-arginine-ornithine- | |
| | binding protein) | |
| YdcS | Unknown | E. coli |
| (b1440) | (putative, spermidine) | |
| YehZ | Unknown | E. coli |
| | (putative) | |
| YejA | Unknown | E. coli |
| | (putative, homology to | |
| | periplasmic oligopeptide- | |
| | binding protein - | |
| | Helicobactr pylori) | |
| YgiS | Oligopeptides | E. coli |
| (b3020) | (putative) | |
| YhbN | Unknown | E. coli |
| YhdW | Unknown (putative, amino | E. coli |
| | acids) | |
| YliB | Unknown (putative, | E. coli |
| (b0830) | peptides) | |
| YphF | Unknown (putative sugars) | E. coli |
| Ytrf | Acetoin | B. subtilis |

The invention is not limited by the source organism from the PBPs are isolated. In addition to Table I, which simply illustrates various enzymes isolated from various organisms, other organisms from which PBPs may be isolated include thermophilic and hyperthermophilic organisms. Binding proteins isolated from these thermophilic and hyperthermophilic organisms offer several potential advantages over binding proteins isolated from mesophilic organisms. In addition to being resistant to high temperatures, proteins isolated from thermophilic and hyperthermophilic have higher resistance to chemical denaturants, may be less difficult to purify, and may be less susceptible to microbial contamination. Table II provides examples of a few representative organisms wherefrom binding proteins may be isolated.

TABLE II
Examples Thermophilic and Hyperthermophilic
Organisms Harboring PBPs

Thermophilic Organisms
Aeropyrum pernix
Aquifex aeolicus
Bacillus stearothermophilus
Geobacillus kaustophilus
Methanopyrus kandleri
Pyrococcus horikoshii
Pyrococcus abyssi
Sulfolobus solfataricus
Thermoanaerobacter tengcongensis
Thermotoga maritima
Thermotoga neapolitana
Thermococcus kodakaraensis
Thermus thermophilus

Other examples of binding proteins upon which the mutant protein library may be based include, but are not limited to, intestinal fatty acid binding proteins (FABPs). The FABPs are a family of proteins that are expressed at least in the liver, intestine, kidney, lungs, heart, skeletal muscle, adipose tissue, abnormal skin, adipose, endothelial cells, mammary gland, brain, stomach, tongue, placenta, testis, retina. The family of FABPs is, generally speaking, a family of small intracellular proteins (˜14 kDa) that bind fatty acids and other hydrophobic ligands through non-covalent interactions. See Smith, E. R. and Storch, J., J. Biol. Chem., 274 (50):35325-35330 (1999), which is hereby incorporated by reference in its entirety. Members of the FABP family of proteins include, but are not limited to, proteins encoded by the genes FABP1, FABP2, FABP3, FABP4, FABP5, FABP6, FABP7, FABP(9) and MP2. Proteins belonging to the FABP include I-FABP, L-FABP, H-FABP, A-FABP, KLBP, mal-1, E-FABP, PA-FABP, C-FABP, S-FABP, LE-LBP, DA11, LP2, Melanogenic Inhibitor, to name a few.

In one embodiment of the present invention, the isolated proteins are mutants of PBPs. In particular, the isolated mutant PBP is a mutant of MBP or GGBP. Examples of mutant GGBPs are described in United States Pre-Grant Publication Nos. 2003/0153026, 2003/0134346 and 2003/0130167, which are hereby incorporated by reference. A “mutant protein” is used herein as it is in the art. In general, a mutant protein can be created by addition, deletion or substitution of a reference primary structure of the protein or polypeptide, e.g., a wild-type protein. In general, a mutant protein may be at least 70%, 75%, 80%, 85%, 90%, 95%, 96%, 97%, 98% or 99% identical to a reference protein. The mutant proteins may be mutated to bind more than one ligand in a specific manner. Indeed, the mutant proteins may possess a similar specificity that the reference protein has, i.e., the mutant is specific for the same ligand, in addition to specificity towards another target ligand.

Likewise, the mutant proteins may be able to only bind a ligand or ligands that the reference protein does not bind. Methods of generating mutant proteins and mutant protein libraries are well-known in the art. For example, Looger, et al., (Nature 423 (6936): 185-190 (2003)), which is hereby incorporated by reference, disclose methods for re-designing binding sites within periplasmic binding proteins that provide new analyte-binding properties for the proteins. These mutant binding proteins retain the ability to undergo conformational change, which can produce a directly generated signal upon analyte-binding. By introducing between 5 and 17 amino acid changes, Looger, et al. constructed several mutant proteins, each with new selectivities for TNT (trinitrotoluene), L-lactate, or serotonin. For example, Looger et al. generated L-lactate binding proteins from ABP, GGBP, RBP, HBP and QBP. In one embodiment, the device comprises GGBP specific for glucose, a FABP specific for fatty acids, and a GGBP derivative where the GGBP derivative specifically binds L-lactate.

As a practical matter, whether any particular polynucleotide or polypeptide is at least 90%, 95%, 96%, 97%, 98% or 99% identical to a reference polynucleotide sequence or amino acid sequence, respectively, can be determined conventionally using known computer programs such the Bestfit program (Wisconsin Sequence Analysis Package, Version 8 for Unix, Genetics Computer Group, University Research Park, 575 Science Drive, Madison, Wis. 53711). When using Bestfit or any other sequence alignment program to determine whether a particular sequence is, for instance, 95% identical to a reference sequence according to the present invention, the parameters are set, of course, such that the percentage of identity is calculated over the full length of the reference amino acid sequence and that gaps in homology of up to 5% of the total number of nucleic acid bases or amino acid residues in the reference sequence are allowed. All sequences listed utilize the convention for base listing established in the World Intellectual Property Organization (WIPO) Handbook on Industrial Property Information and Documentation, Standard ST.25: Standard for the Presentation of Nucleotide and Amino Acid Sequence Listings in Patent Applications (1998), including Tables 1 through 6 in Appendix 2, herein incorporated by reference.

The mutant binding proteins are isolated from a protein library. Generation of protein libraries is well known in the art and includes, but is not limited to, targeted random mutagenesis, and random mutagenesis, such as through chemical mutagenesis such as those described in Ausubel, FMR, et al., Current Protocols in Molecular Biology, Vol 1. John Wiley & Sons, Inc., New York, N.Y. (1998), which is hereby incorporated by reference. Specific methods of mutagenesis include, but are not limited to, chemical mutagenesis using, for example, sodium bisulfite or hydroxylamine (Myers, R. M., et al., Science 229:242-247 (1985); Sikorski, R. S., and Boeke, J. D., Meth. Enzymol. 194:302-318 (1991)), linker insertion mutagenesis (Heffron, F., et al., Proc. Natl. Acad. Sci. USA 75:6012-6016 (1978)), deletion mutagenesis (Lai, C. J., and Nathans, D., J. Mol. Biol. 89:179-193 (1974); McKnight, S. L., and Kingsbury, R., Science 217:316-324 (1982)), enzyme misincorporation mutagenesis (Shortle, D., et al., Proc. Natl. Acad. Sci. USA 79:1588-1592 (1982)), oligonucleotide-directed mutagenesis (Hutchinson, C A., et al., J. Biol. Chem. 253:6551-6560 (1978); Zoller, M. J., and Smith, M., Nucl. Acids Res. 10:6487-6500 (1982); Taylor, J. W., et al., Nucl. Acids Res. 13:8765-8785 (1985)), and cassette mutagenesis (Lo, K.-M., et al., Proc. Natl. Acad. Sci. USA 81:2285-2289 (1984); Wells, J. A., et al., Gene 34:315-323 (1985)). To improve the fidelity and efficiency of mutagenesis, the use of the polymerase chain reaction (PCR) for mutagenesis is also an option (Higuchi, R., et al., Nucl. Acids Res. 16:7351-7367 (1988); Leung, D. W., et al., Technique 1:11-15 (1989); Clackson, T., and Winter, G., Nucl. Acids Res. 17:10163-10170 (1989)). Other examples of protocols for generating mutant protein libraries include those described in “Combinatorial Peptide Protocols” Cabilly, S. Ed., Humana Press (1998), which is hereby incorporated by reference. (See also Miller et al., (1992) A Short Course in Bacterial Genetics, CSHL Press, Cold Spring Harbor, N.Y.; and Greener et al., (1994) Strategies in Mol Biol 7:32-34, which are hereby incorporated by reference.) For example, to analyze protein structure-function relationships, one amino acid change per coding sequence is desired (1-2 base changes per 1000 nucleotides). In directed evolution strategies, mutation frequencies of 1-4 amino acid changes per coding sequence (2-7 nucleotide changes) are desired (Wan, L., et al., Proc. Natl. Acad. Sci. USA, 95:12825-12831 (1998); Cherry, J. R., et al., Nature Biotechnology 17:379-384 (1999), both of which are hereby incorporated by reference). Other mutation strategies involve highly mutagenized libraries containing 20 point mutations per gene (Daugherty, P. S., et al., Proc. Natl. Acad. Sci. USA 97:2029-2034 (2000), hereby incorporated by reference). As used herein, a “protein library” comprises a collection of two or more proteins that have related or similar amino acid sequences to each other and/or the reference. Likewise, a DNA library comprises a collection of two or more polynucleotides, such as DNA or cDNA. In one embodiment, the mutant protein library is generated through targeted random mutagenesis, using error prone PCR. In one embodiment, the library is not a phage display library.

In one embodiment, the protein libraries or subsets of libraries will comprise mutant members in which each mutant comprises 10 or fewer amino acid mutations per coding sequence. As used herein, a coding sequence is a polynucleotide that codes for the mutant protein. A coding sequence can be a gene, which may include introns, or it may be polynucleotide, such as DNA, cDNA or mRNA, that codes for a protein, without the intrusion of introns or other non-coding sequences. In one particular example, mutant proteins will comprise fewer than 5 amino acid mutations per gene, such as 4, 3, 2 or 1 mutation(s) per mutant protein. As used herein, for example, “5 amino acid mutations” indicates that 5 positions along the primary amino acid chain of the wild-type reference protein are targeted for mutation. At these 5 positions, the amino acid normally occurring at each position may be deleted, or any amino acid may be randomly inserted at any or all of these five amino acid positions. The amino acids inserted may be naturally occurring or non-naturally occurring. The non-natural amino acids can be used to aid in detection of the mutant proteins, or can be used to alter the binding characteristics of the mutant protein. Exemplary mutations of binding proteins include the addition or substitution of non-naturally occurring amino acids and are described in Turcatti, et al. J. Biol. Chem. 271(33): 19991-19998 (1996), which is hereby incorporated by reference. When binding proteins, e.g., PBPs, are mutated to form the mutant protein library, amino acid residues with direct ligand contact can be chosen for mutation. Alternatively, amino acids that do not directly contact the ligand during ligand binding may also be chosen for points of mutation. In one embodiment, only those amino acid residues in the wild-type binding protein with direct ligand contact are chosen for mutation. In another embodiment, only those amino acid residues in the wild-type binding protein without direct ligand contact are chosen for mutation. In yet another embodiment, a combination of amino acids that do and do not directly contact the ligand may be mutated.

Individual members of the protein library are encoded by expression vectors comprising polynucleotides encoding the mutant proteins. A set of expression vectors will, in turn, collectively encode the various members of the mutant protein library.

The expression vectors used in the methods of the current invention comprise polynucleotides encoding the mutant binding proteins. Recombinant constructs may be introduced into host cells using well known techniques such as infection, transduction, transfection, transvection, electroporation and transformation. The vector may be, for example, a phage, plasmid, viral or retroviral vector. Retroviral vectors may be replication competent or replication defective. In the latter case, viral propagation generally will occur only in complementing host cells.

The polynucleotides encoding the mutant proteins may be joined to a vector containing a selectable marker for propagation in a host. A plasmid vector can be introduced by such processes including, but not limited to, heat shock, using a precipitate, such as a calcium phosphate precipitate, or in a complex with a charged lipid. If the vector is a virus, such as, but not limited to, an adeno-associated virus, lentivirus or a parvovirus, it may be packaged in vitro using an appropriate packaging cell line and then transduced into host cells.

In one embodiment, the expression vectors comprise cis-acting control regions to the polynucleotide of interest. Appropriate trans-acting factors may be supplied by the host, supplied by a complementing vector or supplied by the vector itself upon introduction into the host.

In certain preferred embodiments in this regard, the vectors provide for specific expression, which may or may not be inducible and/or cell type-specific. Particularly preferred among such vectors are those inducible by environmental factors that are easy to manipulate, such as temperature and nutrients or other additives such as, but not limited to, IPTG (isopropyl thiogalactoside).

Expression vectors useful in the present invention include, but are not limited to, chromosomal-, episomal- and virus-derived vectors, e.g., vectors derived from bacterial plasmids, bacteriophage, yeast episomes, yeast chromosomal elements, viruses such as, but not limited to, baculoviruses, papova viruses, vaccinia viruses, adenoviruses, fowl pox viruses, pseudorabies viruses and retroviruses, and vectors derived from combinations thereof, such as cosmids and phagemids.

The polynucleotide encoding the mutant protein should be operably linked, with or without splicing, to an appropriate promoter, such as, but not limited to, the phage lambda PL promoter, the E. coli lac, trp and tac promoters, the SV40 early and late promoters and promoters of retroviral LTRs. Other suitable promoters will be known to the skilled artisan. The expression constructs will further contain sites for transcription initiation, termination and, in the transcribed region, a ribosome binding site for translation. The coding portion of the mature transcripts expressed by the constructs will generally include a translation initiating AUG at the beginning and a termination codon appropriately positioned at the end of the polypeptide to be translated.

In one embodiment, the expression vectors will include at least one selectable marker. Such markers include dihydrofolate reductase or neomycin resistance for eukaryotic cell culture and tetracycline, chloramphenicol, kanamycin or ampicillin resistance genes for culturing in E. coli and other bacteria.

Among vectors for use in bacteria include pA2, pQE70, pQE60 and pQE-9, available from Qiagen (Valencia, Calif., USA); pBS vectors, Phagescript vectors, Bluescript vectors, pNH8A, pNH16a, pNH18A, pNH46A, available from Stratagene (La Jolla, Calif., USA); and ptrc99a, pKK223-3, pKK233-3, pDR540, pRIT5; and the pLP-Adeno-X family of vectors, available from Becton, Dickinson and Company (Franklin, Lakes, N.J., USA). Among preferred eukaryotic vectors are pWLNEO, pSV2CAT, pOG44, pXT1 and pSG available from Stratagene; and pSVK3, pBPV, pMSG and pSVL. Other suitable vectors will be readily apparent to the skilled artisan.

Suitable bacterial promoters for use in the present invention include, but are not limited to, the E. coli lacI and lacZ promoters, the T3 and T7 promoters, the gpt promoter, the lambda PR and PL promoters and the trp promoter. Suitable eukaryotic promoters include the CMV immediate early promoter, the HSV thymidine kinase promoter, the early and late SV40 promoters, the promoters of retroviral LTRs, such as those of the Rous sarcoma virus (RSV), and metallothionein promoters, such as the mouse metallothionein-I promoter.

Introduction of the construct into the host cell can be effected by calcium phosphate transfection, DEAE-dextran mediated transfection, cationic lipid-mediated transfection, electroporation, transduction, heat shock, infection or other methods. Such methods are described in many standard laboratory manuals, such as Davis et al., Basic Methods In Molecular Biology, (1986), which is hereby incorporated by reference.

Transcription of the DNA encoding the mutant polypeptides or proteins by higher eukaryotes may be increased by inserting an enhancer sequence into the vector. Enhancers are cis-acting elements of DNA, usually about from 10 to 300 bp that act to increase transcriptional activity of a promoter in a given host cell-type. Examples of enhancers include the SV40 enhancer, which is located on the late side of the replication origin at bp 100 to 270, the cytomegalovirus early promoter enhancer, the polyoma enhancer on the late side of the replication origin, and adenovirus enhancers.

For secretion of the translated protein into the lumen of the endoplasmic reticulum, into the periplasmic space or into the extracellular environment, appropriate secretion signals, such as those signaling the expression of the protein as a soluble protein within the periplasmic space, may be incorporated into the expressed polypeptide. The signals may be endogenous to the polypeptide or they may be heterologous signals.

A collection of host cells will harbor the expression vectors encoding the various members of the protein library. Thus, a collection of host cells will “collectively” comprise the set of expression vectors encoding all the members of the protein library. In one embodiment, each individual host cell will comprise only one member of the protein library. It is possible, however, that some of individual members of the host cell collection will not contain expression vectors, or that some individual members of the host cell collection will contain more than one expression vector. Provided that the collection of cells contains most, if not all, of the expression vectors encoding various members of the mutant protein library, the host cells will, for the purposes of the present invention, “collectively” comprise the set of expression vectors encoding the members of the mutant protein library.

Representative examples of appropriate hosts include bacterial cells, such as, but not limited to, E. coli, Streptomyces and Salmonella typhimurium cells; fungal cells, such as yeast cells; insect cells such as Drosophila S2 and Spodoptera Sf9 cells; animal cells such as, pancreatic primary cell lines, CHO, COS and Bowes melanoma cells; and plant cells. Appropriate culture media and conditions for the above-described host cells and protein expression are well known in the art.

The cultured cells, collectively harboring the library of expression vectors and library of proteins, are contacted with a ligand, and differences in the interaction of the cells with the ligand can be detected. The ligand that is contacted with the cultured cells may or may not be the ligand to which the wild-type binding protein binds. In one embodiment, the ligand is labeled with a detectable label. A label, as used herein, is intended to mean a chemical compound or ion that possesses or comes to possess a detectable signal. In particular, the label can be a luminescent molecule such as a fluorescent, phosphorescent, bioluminescent, electrochemical or chemiluminescent molecule. The label can also be a radioactive label, or a label capable of generating a detectable signal in the presence of a substrate, such as, but not limited to, ³H and ³²P. Examples of labels include, but are not limited to, transition metals, lanthanide ions, and other chemical compounds. In one embodiment, the label is a fluorophore selected from the group consisting of fluorescein, coumarins, rhodamines, 5-TMRIA (tetramethylrhodamine-5-iodoacetamide), (9-(2(or 4)-(N-(2-maleimdylethyl)-sulfonamidyl)-4(or 2)-sulfophenyl)-2,3,6,7,12,13,16,17-octahydro-(1H,5H, 11H, 15H-xantheno(2,3,4-ij:5,6,7 i′j′)diquinolizin-18-ium salt) (Texas Reds), 2-(5-(1-(6-(N-(2-maleimdylethyl)-amino)-6-oxohexyl)-1,3-dihydro-3,3-dimethyl-5-sulfo-2H-indol-2-ylidene)-1,3-propyldienyl)-1-ethyl-3,3-dimethyl-5-sulfo-3H-indolium salt (Cy™3), N,N′-dimethyl-N-(iodoacetyl)-N′-(7-nitrobenz-2-oxa-1,3-diazol-4-yl)ethylenediamine (IANBD amide), 6-acryloyl-2-dimethylaminonaphthalene (acrylodan), pyrene, 6-amino-2,3-dihydro-2-(2-((iodoacetyl)amino)ethyl)-1,3-dioxo-1H-benz(de)isoquinoline-5,8-disulfonic acid salt (lucifer yellow), 2-(5-(1-(6-(N-(2-maleimdylethyl)-amino)-6-oxohexyl)-1,3-dihydro-3,3-dimethyl-5-sulfo-2H-indol-2-ylidene)-1,3-pentadienyl)-1-ethyl-3,3-dimethyl-5-sulfo-3H-indolium salt (Cy™5), 4-(5-(4-dimethylaminophenyl)oxazol-2-yl)phenyl-N-(2-bromoacetamidoethyl)sulfonamide (Dapoxyl® (2-bromoacetamidoethyl)sulfonamide)), (N-(4,4-difluoro-1,3,5,7-tetramethyl-4-bora-3a,4a-diaza-s-indacene-2-yl)iodoacetamide (BODIPY® 507/545 IA), N-(4,4-difluoro-5,7-diphenyl-4-bora-3a,4a-diaza-s-indacene-3-propionyl)-N′-iodoacetylethylenediamine (BODIPY 530/550 IA), 5-((((2-iodoacetyl)amino)ethyl) amino)naphthalene-1-sulfonic acid (1,5-IAEDANS), and carboxy-X-rhodamine, 5/6-iodoacetamide (XRIA 5,6). Another example of a label is BODIPY-FL-hydrazide. Other luminescent labels include lanthanides such as europium (Eu3+) and terbium (Tb3+), as well as metal-ligand complexes of ruthenium [Ru(II)], rhenium [Re(I)], or osmium [Os(II)], typically in complexes with diimine ligands such as phenanthroline.

In another embodiment of the present invention, the ligand that is contacted with the host cells is not labeled. When the ligand itself is not labeled, the binding event between the ligand and the mutant binding protein will generate a detectable signal. One example of an embodiment in which the binding event of the ligand and the mutant protein is detectable is when a detectable conformational change occurs in the mutant binding protein. For example, in surface plasmon resonance (SPR), a “refractive index” is used to determine the binding specificity between two molecules, assess how much of a given molecule is present and active, and quantitatively define both the kinetics and affinity of binding. SPR may be used to visualize the progress of biomolecular binding through time by defining the change in mass concentration that occurs on a sensor surface during the binding and dissociation process. As used herein, “refractive index” is used as it is in the art, i.e., it is a measure of the ratio of the velocity of a specific radiation in a vacuum to the velocity in a given medium. The direction of a ray of light is changed (refracted) upon passage from one medium to another of different density or when traversing a medium whose density is not uniform. Other suitable means of detection that utilize refractive index include but are not limited to, reflectance spectrophotometers and long period grating means. Methods of SPR are described in U.S. application Ser. No. 10/039,799 (U.S. Pre-grant Publication No. 2003/0130167), which is hereby incorporated by reference. In one particular embodiment, the mutant binding protein may possess a label. The detection of the ligand in this embodiment is made possible by the conformational change that the mutant binding protein undergoes when it binds to the ligand. This conformational change will, in turn, change the relative positions of the label on the mutant binding protein. In one embodiment, the mutant proteins comprise a label, such as a fluorophore. Examples of such labels have been described previously herein. In another embodiment, the mutant binding proteins may be fusion proteins comprising, a fluorescent protein.

The mutant fusion proteins of the current invention may include one, two, three, four or more fluorescent proteins. If the fusion proteins of the current invention contain more than one fluorescent protein, the fluorescent proteins may or may not be chemically identical. Fluorescent proteins are easily recognized in the art. Examples of fluorescent proteins that are part of fusion proteins of the current invention include, but are not limited to, green fluorescent proteins (GFP, AcGFP, ZsGreen), red-shifted GFP (rs-GFP), red fluorescent proteins (RFP, including DsRed2, HcRed1, dsRed-Express), yellow fluorescent proteins (YFP, Zsyellow), cyan fluorescent proteins (CFP, AmCyan), and a blue fluorescent protein (BFP), as well as the enhanced versions and mutations of these proteins. For some fluorescent proteins enhancement indicates optimization of emission by increasing the proteins' brightness or by creating proteins that have faster chromophore maturation. These enhancements can be achieved through engineering mutations into the fluorescent proteins.

In one embodiment, the mutant proteins comprise at least two fluorescent proteins such that a resonance energy transfer from one fluorescent donor protein to another fluorescent acceptor protein is the detectable signal. In particular, the resonance energy transfer is in the form of fluorescence resonance energy transfer (FRET). When FRET is used to detect the presence or absence of the ligand, one label is the donor or the acceptor, and another label is the donor or acceptor. The terms “donor” and “acceptor,” when used in relation to FRET, are readily understood in the art. Specifically, a donor is the molecule that will absorb a photon of light and subsequently initiate energy transfer to the acceptor molecule. The acceptor molecule is the molecule that receives the energy transfer initiated by the donor and, in turn, emits a photon of light. The efficiency of FRET is dependent upon the distance between the two fluorescent partners and can be expressed mathematically by: E=R₀⁶/(R₀⁶+r⁶), where E is the efficiency of energy transfer, r is the distance (in Angstroms) between the fluorescent donor/acceptor pair and R₀ is the Förster distance (in Angstroms). The Förster distance, which can be determined experimentally by readily available techniques in the art, is the distance at which FRET is half of the maximum possible FRET value for a given donor/acceptor pair. In this embodiment, the binding of the ligand to the first fluorescent protein on the mutant fusion protein causes a conformational change, permitting an energy transfer from a donor molecule, e.g., the first fluorescent protein, to the acceptor molecule e.g., the second fluorescent protein, which is then detectable via a signal, for example, fluorescence. The value of the fluorescence measured can be intensity or lifetime. Thus, the fluorescent measurement can be directly or indirectly tied to the presence or absence of the ligand in the host cell. Furthermore, the intensity of the fluorescent signal may also be correlated to the concentration of the ligand within the host cell, indicating the relative or absolute affinity of the mutant protein towards the ligand.

In addition to fusion proteins, the mutant proteins may also be expressed in other modified forms, which may include, but are not limited to, secretion signals and heterologous functional regions. For instance, a region of additional amino acids, particularly charged amino acids, may be added to the N-terminus of the polypeptide to improve stability and persistence in the host cell, during purification, or during subsequent handling and storage. Also, peptide moieties may be added to the polypeptide to facilitate purification. Such regions may be removed prior to final preparation of the mutant polypeptide or protein. The addition of peptide moieties to polypeptides to engender secretion or excretion, to improve stability and to facilitate purification, among others, are familiar and routine techniques in the art.

The host cells, harboring the mutant proteins, are then contacted with the ligand at various concentrations. The concentration of ligand used will depend on the desired characteristics of the binding protein that is sought. An artisan of ordinary skill will be able to determine which concentrations are appropriate for their mutant proteins' desired characteristics. For example, the concentration of ligand used to contact the host cells can be 0.001 μM or lower, to about 1 mM or higher. Once contacted, differences in interacting with the ligand, among individual host cells, are detected. These differences in host cell interaction with the ligand are indicative of differences in the binding ability of the mutant proteins towards the ligand. These differences in interaction may also be indicative of the mutant protein's stability. Provided there is a detectable difference in the host cells' interaction with the ligand, these differences in interaction can be detected or measured using any means that detects the energy transfer, such as a fluorometer, which can also detect fluorescent intensity and chemiluminescence, or any other means appropriate for detecting differences in interaction, such as, but not limited to a scintillation counter and a phosphoimager. The differences may also be measured or detected visually, without the aid of equipment. As stated previously, the detectable signal could be indicative of the presence of the ligand, or the signal could represent a binding event between the ligand the mutant protein. Among other measurements, the differences in the interaction of individual host cells can be assessed by detecting the differences in the quantity, level or concentration of ligand within the cells. Other differences in interaction between the host cell and the ligand may include the length of time the ligand is detected within the host cells, as well as measurable differences in the signal created by the binding event. Of course, one difference includes, but is not limited to, the presence and total absence of a detectable signal within the individual host cells. In one embodiment, the individual host cells displaying a desired interaction are detected and separated, with at least one additional subsequent round of detection and separation from among these initial “positive” individual host cells. The cells displaying the desired interaction may also be enriched, for example, by concentrating or culturing to produce a greater population of cells, prior to subsequent rounds of screening. The subsequent detection and separation may utilize the same or different detection means as the initial detection and separation. Additionally, the subsequent detection and separation may utilize the same or different concentrations of the ligand; and the ligand, if labeled, can be labeled with the same or different label. It is also within the scope of the present methods that a different ligand altogether is used in any of the subsequent rounds of detection and separation. The individual host cells that continue to display desired interaction with the ligand, after these one or more subsequent rounds of detection and separation, are then separated from host cells no longer displaying the desired interaction.

Unlike other methods of screening protein libraries, the methods of identifying molecules of interest are not dependent upon lysing the host cells during or before the detection event. Accordingly, in one embodiment of the current invention, the host cells are not lysed during detection of the cells that possess mutant proteins capable of binding the ligand.

In one embodiment, the signal, e.g., the label or binding event, is detected using fluorescence activated cell sorting (FACS). Protocols involving detecting cells with a particular phenotype using FACS, such as Chen et al., Nature Biotechnology, 19: 537-542 (2001), which is hereby incorporated by reference, are well known in the art. Other FACS protocols are descried in Boder, E. T., and Wittrup, K. D., Biotechnol. Prog., 14:55-62 (1998), which is hereby incorporated by reference.

After or during detection, the individual host cells that possess mutant proteins capable of specifically binding the ligand are separated from those individual host cells that do not possess mutant proteins capable of specifically binding the ligand, thus isolating the stable mutant proteins capable of specifically binding the ligand.

These methods simultaneously screen for ligand affinity, specificity and protein stability in that the isolated mutant proteins are stable enough to exist in the host cell's intracellular environment. In other words, the absence of a detectable signal from individual host cells indicates that the mutant protein within the individual host cell was either unstable or was unable to specifically bind the ligand of choice. Accordingly, the methods of the current invention are useful in screening for both ligand affinity, specificity and protein stability of proteins that reversibly bind their target ligand(s).

If desired, the mutant protein can be further recovered and purified from individual host cells by well-known methods including, but not limited to, ammonium sulfate or ethanol precipitation, acid extraction, anion or cation exchange chromatography, phosphocellulose chromatography, hydrophobic interaction chromatography, affinity chromatography, hydroxylapatite chromatography, immobilized metal ion affinity chromatography (IMAC) or metal chelate affinity chromatography (MCAC), and lectin chromatography. High performance liquid chromatography (“HPLC”) may also be employed for purification. Well-known techniques for refolding protein may be employed to regenerate active conformation when the fusion protein is denatured during isolation and/or purification.

Recombinant polypeptides typically are produced using a host cell (or derivative thereof) into which a nucleic acid that can give rise to a mutant protein to be identified Such a nucleic acid may continue to exist as an extrachromosomal element or may integrate into the host cell genome. Methods for producing recombinant polypeptides in host cells can be practiced as a matter of routine experimentation. For example, routine protocols for rendering bacteria capable of taking up and maintaining exogenous polynucleotides (i.e., making them “transformable” or “competent”), and for transforming them are well known to the skilled practitioner.

Recombinant polypeptides can include one or more detection and/or purification tags. Purification and detection tags are well known in the art and include peptides such as polyhistidine motifs, polycysteine motifs, streptavidin, biotin, antigenic epitopes, glutathione-S-transferase, beta-galactosidase, and beta-amylase. Nucleic acids that encode a purification tag can be combined with a nucleic acid encoding a mutant polypeptide to make a nucleic acid that encodes a tagged recombinant mutant polypeptide. This tagged mutant protein may also be a tagged mutant fusion protein. In some cases the resultant nucleic acid “expression construct” can give rise to the tagged recombinant polypeptide, e.g., after it is introduced into a host cell or added to a host cell extract.

Polycysteine tags (Cys-tags) can interact with biarsenical reagents, and are one type of detection/purification tag. A Cys-tag can vary in size and typically contains at least 6 (e.g., 5-10, 10-15, or 15-20) amino acids. A Cys-tag can be present at the N-terminus, C-terminus, and/or internal to a recombinant polypeptide. In general, a Cys-tag includes two or more cysteines that are in an appropriate configuration for interacting with the biarsenical molecule. Cys-tags typically are alpha-helical and include at two to ten (e.g., 2, 3, 4, 5 or 6) cysteine amino acids. Typically, the Xaa amino acids have a high propensity to form alpha-helical structures. A Cys-tag may be arranged such that the side chains of two pairs of cysteines are exposed one the same face of an alpha-helix. An exemplary Cys-tag is the peptide CCXaaXaaCC, wherein each Xaa is any amino acid. The cysteines in this Cys-tag are positioned to encourage arsenic interaction across helical turns. A Cys-tag need not be completely helical to react with a biarsenical reagent. For example, reaction of a first arsenic of a biarsenical with a pair of cysteines may nucleate an alpha-helix and position two other cysteines favorably for reacting with a biarsenical molecule.

Purifying an identified mutant protein comprises separating it (completely or partially) from at least one contaminant. Identified molecules can be purified from undesired contaminants purified via one or more purification steps. Some purification processes can result in a “homogeneous” preparation comprising at least about 70% (e.g., at least about 80%, at least about 90% by weight, or at least about 95%) by weight of the identified molecule(s). Other purification processes (e.g., obtaining a cell lysate, cell extract or cell culture supernatant) can result in a lower degree of purification, which may nonetheless be suitable for a particular use. For example, cell lysates and cell extracts can be used to make an in vitro translation transcription (IVTT) system.

Steps for purifying identified protein(s) from cultured cells can depend on whether the identified protein(s) remains inside cultured cells or are secreted into the cell culture growth medium. For identified proteins that remain within cultured cells, purification typically involves disrupting the cells (e.g., by mechanical shear, freeze/thaw, osmotic shock, chemical treatment, and/or enzymatic treatment). Such disruption results in a cell lysate that contains the identified molecule and other cellular constituents. In some cases, much of the undesired cellular material can be removed by filtration or centrifugation to yield a cell extract that contains the partially purified omolecule. For identified proteins that are secreted into the cell culture growth medium, undesired cellular constituents present less of a problem, although host cell constituents can be present in the culture medium. Secreted identified proteins can be purified by separating the culture medium from all or most of the cultured cells, e.g., centrifugation or filtration.

Chromatographic techniques often are used to further purify an identified protein from cell culture growth medium, products of cellular metabolism, and/or other cellular constituents. Such techniques can separate polypeptides on the basis of size, charge, hydrophobicity, or presence of purification tags, to name a few. Chromatographic separation schemes can be tailored to particular identified polypeptides, using one or more chromatographic techniques and/or separation media. During chromatographic separation, an identified polypeptide can move at a different rate through a separation medium, or can adhere selectively to the separation medium, relative to undesired molecules. In addition, an identified protein can be positively selected or negatively selected. Thus, in some negative seletion schemes using chromatographic separation, identified molecules can be separated from undesired molecules when the undesired molecules adhere to the separation medium and the identified molecule(s) do(es) not. In such a scheme, the identified molecules are present in the eluate or flow-through and undesired molecules are retained in association with the separation medium. Alternatively, in positive selection schemes, the identified molecules can be separated from undesired molecules when identified (desired) molecules adhere to the separation medium and undesired molecules do not. In such a scheme, the eluate or flow-through contains undesired molecules, and the separation medium retians the the identified proteins. The identified molecules can be then be recovered, for example, by exposing the separation medium to a chemical or enzymatic agent suitable for dissociating the desired polypeptide.

Ion exchange chromatography is just one chromatographic technique that can be used to purify the identified proteins. In ion exchange chromatography, charged portions of molecules in solution are attracted by opposite charges of an ion exchange medium when the ionic strength of the solution is sufficiently low. Solutes can be dissociated from an ion exchange medium and eluted from an ion exchange column by increasing the ionic strength of the solution. Changing the pH to alter solute charge is another way to dissociate solutes from an ion exchange medium. Ionic strength and/or pH can be changed gradually (gradient elution) or stepwise (stepwise elution).

Metal ion affinity chromatography (MIAC) is another chromatographic technique that can be used to purify identified molecules. MIAC is an affinity chromatography technique that involves the binding of desired molecules to metal ions. Immobilized metal ion affinity chromatography (IMAC) is a type of MIAC technique that involves the use of a separation medium to which metal ions have been chelated. The identified polypeptides may be immobilized on such a metal chelate substrate, reportedly via interaction(s) between metal ion(s) and electron-donating amino acid(s) such as histidine and cysteine. Thus, IMAC routinely is used to purify recombinant polypeptides that include polyhistidine or polycysteine motifs (tags). Whether, and with what affinity, a particular desired polypeptide will bind to a metal chelate substrate can depend on the conformation of the polypeptide, the number of available coordination sites on the chelated metal ion ligand, and the number of amino acid side chains available to bind the chelated metal ion ligand.

Electrophoresis techniques can also be used to purify desired polypeptides. Electrophoresis is based on the principle that charged particles migrate in an applied electrical field. If electrophoresis is carried out in solution, molecules are separated according to their surface net charge density. If carried out in semisolid materials (gels), the matrix of the gel adds a sieving effect so that particles migrate according to both charge and size.

Gel-based electrophoresis can be carried out in a variety of formats, including in standard-sized gels, minigels, strips, gels designed for use with microtiter plates and other high throughput (HTS) applications, and the like. Two commonly used media for gel electrophoresis and other separation techniques are agarose and polyacrylamide gels. In general, electrophoresis gels can be either in a slab gel or tube gel form.

Electrophoresis can performed in the presence of a charged detergent like sodium dodecyl sulfate (SDS) which coats, and thus equalizes the charges of most polypeptides such that migration is more dependent upon size (molecular weight) than charge. Polypeptides often are electrophoresed in the presence SDS, e.g., SDS-PAGE techniques. In addition to SDS, one or more other denaturing agents, such as urea, can be used to minimize the effects of secondary and tertiary structure on the electrophoretic mobility of polypeptides. Such additives typically are not necessary for nucleic acids, which have a similar surface charge irrespective of their size and whose secondary structures generally are broken up by the heating of the gel that happens during electrophoresis.

Isoelectric focusing (IEF) is an electrophoresis technique that involves passing a mixture through a separation medium having a pH gradient or other pH function. An IEF system has an anode at a position of relatively low pH end and a cathode disposed at another position of higher pH. Molecules having a net positive charge under the acidic conditions near the anode will move away from the anode. As they move through the IEF system, molecules enter zones having less acidity, causing their positive charges to diminish. Each molecule will stop moving when it reaches a point in the system having a pH equivalent to its isoelectric point (pI).

Two-dimensional (2D) electrophoresis involves a first electrophoretic separation in a first dimension, followed by a second electrophoretic separation in a second, transverse dimension. In a common 2D electrophoretic method, polypeptides are subjected to IEF in a polyacrylamide gel in the first dimension, which results in separation on the basis of pI, and the molecules are then subjected to SDS-PAGE in the second dimension, resulting in further separation on the basis of size.

Capillary electrophoresis (CE) achieves molecular separations on the same basis as conventional electrophoretic methods, but does so within the environment of a narrow capillary tube (25 to 50 .mu.m). The main advantages of CE are that very small volumes of sample are all that are required, and that separation can be performed very rapidly, thus increasing sample throughput relative to other electrophoresis formats. Examples of CE include capillary electrophoresis isoelectric focusing (CE-IEF) and capillary zone electrophoresis (CZE). Capillary zone electrophoresis (CZE) is a technique that separates molecules on the basis of differences in mass to charge ratios, which permits rapid and efficient separations of charged substances. In general, CZE involves introducing a sample into a capillary tube and applying an electric field to the tube. The electric potential of the field pulls the sample through the tube and separates it into its constituent parts. Constituents of the sample having greater mobility travel through the capillary tube faster than those with slower mobility. As a result, the constituents of the sample are resolved into discrete zones in the capillary tube during their migration through the tube. An on-line detector can be used to continuously monitor the separation and provide data as to the various constituents based upon the discrete zones.

The methods of the present invention may optionally comprise subjecting the host cells to various stressful environments. For example, the host cells may be subjected to heat shock to further assess the stability of the expressed mutant protein. In one embodiment, the stressing event can be placed upon the host cells prior to the detection and separation of the individual host cells that display a desired interaction. After or during the stressing event, e.g., heat shock, the host cells can then be contacted with the ligand, and differences in interaction can be determined, as previously described. In another embodiment, the stressing event may be placed upon host cells after the initial detection and separation of the individual host cells that display a desired interaction with the ligand, followed by subsequent detection and separation of host cells that continue to display desired interaction from individual host cells that no longer display the desired interaction.

The present invention also relates to methods of isolating polynucleotides that encode mutant proteins. The methods comprise culturing host cells under conditions suitable for protein expression. The collection of host cells comprise collectively a set of expression vectors, and this collection of expression vectors encodes the various members of a protein library of mutant binding proteins. The cultured cells, harboring the expression vectors, are contacted with a ligand, and differences in interaction, among the individual host cells, with the ligand are detected. The individual host cells displaying the desired interaction with the ligand are then separated from individual host cells that do not display the desired interaction with the ligand. Optionally, the polynucleotides encoding the mutant proteins capable of binding the ligand can be sequenced.

When the methods of the present invention are used to isolate polynucleotides encoding mutant proteins capable of specifically binding a ligand, the methods further comprise isolating the expression vector from the individual host cells harboring these mutant proteins. Processes of isolating expression vectors, i.e., polynucleotides, from host cells are well known to the artisan of ordinary skill. Standard polynucleotide sequencing techniques can then be applied to the isolated polynucleotide to determine the genetic sequence of the mutant protein that is capable of specifically binding the ligand. Similar to polynucleotide isolation, techniques for sequencing polynucleotides are well known in the art.

The present invention also relates to methods of generating stable mutant binding proteins. For example, once a polynucleotide encoding a stable mutant protein capable of binding the ligand of choice has been isolated, this mutant protein can be further mutagenized to produce a subsequent mutant protein library. This subsequent mutant protein library can then be screened for the presence of a stable mutant protein that binds the ligand of choice. This reiterative process of generating a subsequent mutant protein library from mutant protein can be repeated as necessary to enhance the desired characteristics of the stable mutant protein. This reiterative process mimics the affinity maturation process and thus can be used to create binding proteins with increasing affinity for the ligand of choice. Alternatively, the reiterative process can be used to create stable mutant proteins with decreased affinity towards the ligand of choice.

The present invention also relates to polynucleotides that encode individual protein members of mutant binding proteins. The present invention also relates to the library of polynucleotides that collectively encode proteins in mutant binding protein libraries. Specifically, the present invention relates to polynucleotides that encode mutant binding proteins, such as, but not limited to, periplasmic binding proteins, fused with at least one fluorescent protein. In one embodiment of the present invention, the polynucleotide sequences of the polynucleotides of the present invention are at least 80% identical to the polynucleotide sequence listed in SEQ ID NO:1. The polynucleotide sequence of SEQ ID NO:1 is the polynucleotide sequence of wild-type GGBP, fused to the DsRed2 and acGFP fluorescent proteins. Referring to the sequence listed in SEQ ID NO:1, the coding region for the dsRed2 fluorescent protein begins at nucleotide 1 and ends at nucleotide 675; the coding sequence for the wild-type GGBP, coding for a protein 306 amino acids in length, begins at nucleotide 685 and ends at nucleotide 1602; the coding sequence for the acGFP fluorescent protein then begins at nucleotide 1603 and ends at nucleotide 2340. The polynucletide sequence listed in SEQ ID NO:1 also comprises a nucleotide sequence encoding a histidine tag (2341-2358). The dsRed2 protein portion of SEQ ID NO:1 comprises a C117A mutation. In particular embodiments, the polynucleotide sequences of the polynucleotides of the present invention are at least 85%, 90%, 95%, 96%, 97%, 98% and 99% identical to the poynucleotide sequence of SEQ ID NO:1. One example of a polynucleotide with a sequence at least 90% identical to the polynucleotide sequence of SEQ ID NO:1 is the polynucleotide sequence of SEQ ID NO:7.

In one embodiment of the present invention, the polynucleotide sequences of the polynucleotides of the present invention are at least 80% identical to the polynucleotide sequence listed in SEQ ID NO:2. Referring to the sequence listed in SEQ ID NO:2, the coding region for the dsRed2 fluorescent protein begins at nucleotide 1 and ends at nucleotide 675; the coding sequence for the wild-type MBP, coding for a protein 366 amino acids in length, begins at nucleotide 697 and ends at nucleotide 1794; the coding sequence for the acGFP fluorescent protein then begins at nucleotide 1867 and ends at nucleotide 2604. The polynucletide sequence listed in SEQ ID NO:2 also comprises a nucleotide sequence encoding a histidine tag (2605-2622). The dsRed2 protein portion of SEQ ID NO:2 comprises a C 117A mutation. In particular embodiments, the polynucleotide sequences of the polynucleotides of the present invention are at least 85%, 90%, 95%, 96%, 97%, 98% and 99% identical to the poynucleotide sequence of SEQ ID NO:2. One example of a polynucleotide with a sequence at least 90% identical to the polynucleotide sequence of SEQ ID NO:2 is the polynucleotide sequence of SEQ ID NO:8.

In one embodiment of the present invention, the polynucleotide sequences of the polynucleotides of the present invention are at least 80% identical to the polynucleotide sequence listed in SEQ ID NO:3. Referring to the sequence listed in SEQ ID NO:3, the coding region for the dsRed2 fluorescent protein begins at nucleotide 1 and ends at nucleotide 675; the coding sequence for the wild-type GGBP, coding for a protein 310 amino acids in length, begins at nucleotide 685 and ends at nucleotide 1614. The polynucletide sequence listed in SEQ ID NO:3 also comprises a nucleotide sequence encoding a histidine tag (1615-1632). The dsRed2 protein portion of SEQ ID NO:3 comprises a C 117A mutation. In particular embodiments, the polynucleotide sequences of the polynucleotides of the present invention are at least 85%, 90%, 95%, 96%, 97%, 98% and 99% identical to the poynucleotide sequence of SEQ ID NO:3. One example of a polynucleotide with a sequence at least 90% identical to the polynucleotide sequence of SEQ ID NO:3 is the polynucleotide sequence SEQ ID NO:9. Another example of a polynucleotide with a sequence at least 90% identical to the sequence of SEQ ID NO:3 is the polynucleotide sequence of SEQ ID NO:11.

In one embodiment of the present invention, the polynucleotide sequences of the polynucleotides of the present invention are at least 80% identical to the polynucleotide sequence listed in SEQ ID NO:4. Referring to the sequence listed in SEQ ID NO:4, the coding region for the dsRed2 fluorescent protein begins at nucleotide 1 and ends at nucleotide 675; the coding sequence for the wild-type MBP, coding for a protein 366 amino acids in length, begins at nucleotide 697 and ends at nucleotide 1794. The polynucletide sequence listed in SEQ ID NO:4 also comprises a nucleotide sequence encoding a histidine tag (1795-1812). The dsRed2 protein portion of SEQ ID NO:4 comprises a C 117A mutation. In particular embodiments, the polynucleotide sequences of the polynucleotides of the present invention are at least 85%, 90%, 95%, 96%, 97%, 98% and 99% identical to the poynucleotide sequence of SEQ ID NO:4. One example of a polynucleotide with a sequence at least 90% identical to the polynucleotide sequence of SEQ ID NO:4 is the polynucleotide sequence of SEQ ID NO: 10. Another example of a polynucleotide with a sequence at least 90% identical to the sequence of SEQ ID NO:4 is the polynucleotide sequence of SEQ ID NO:12.

In one embodiment of the present invention, only the coding sequence of the wild-type binding protein portion of the mutant fusion protein may be mutated. In another embodiment, only coding sequence of the fluorescent protein portion of the mutant fusion protein may be mutated (See SEQ ID NO:11 and SEQ ID NO:12). In yet another embodiment both the binding protein portion and the fluorescent protein portion may be mutated.

In another embodiment, the invention relates to kits for cloning an amplified nucleic acid molecule. Kits according to the present invention may comprise a carrier means, such as a box, carton, tube or the like, having in close confinement therein one or more containers, such as vials, tubes, ampules, bottles and the like. The kits of the invention may further comprise one or more containers containing one or more additional reagents and compounds, such as one or more polypeptides having polymerase activity, one or more primers, one or more nucleotides (such as dNTPs, ddNTPs and/or rNTPs), one or more polypeptides having reverse transcriptase activity, one or more nucleic acid-modifying enzymes (such as topoisomerases, ligases, phosphatases, etc.), one or more vectors, one or more host cells (particularly one or more of the above-described host cells and most particularly one or more transformation-competent host cells), one or more restriction endonucleases, and one or more recombination proteins. Additional kits of the invention may comprise one or more of the above-described compositions of the invention. These kits and their components are preferably stable upon storage according to the above-described parameters of stability, and may be advantageously used to clone a nucleic acid molecule, preferably an amplified nucleic acid molecule, according to the methods of the invention.

The examples are for illustrative purposes only and are not intended to limit the scope of the invention described herein.

### EXAMPLES

### Example 1

### Mutagenesis of the Glucose-Galactose Binding Protein

The GGBP library was constructed with randomized amino acids at or near protein-glucose H-bonding sites. Mutations were generated in the pGGBP construct by a modified QuikChange method (Stratagene). Using the standard reaction mixture, PCR was performed using primer pairs having randomized nucleotides DDK (where D=A, G, or T, and K=G or T) at the appropriate condon locations. After PCR, the product was digested with DpnI and then a second PCR reaction was performed using primers that placed a cysteine at position 149 creating the mutant E149C. This second PCR reaction corrected base pairing for the randomized amino acid. The library thus created contained 17 randomized codons in total. Any one GGBP gene contained only 2-3 randomized codons, creating a library having an estimated diversity of 40,800. The mutagenesis efficiency of the targeted codons varied from 33-92% over the 17 residues targeted. Thus, plasmid pQE70-GGBP was constructed as described above.

### Example 2

### Screening Mutant GGBP Using a Periplasmic Screening Assay

To quickly screen libraries created by targeted random mutagenesis, individual colonies were induced to express the mutant GGBP. Then 0.5 ml of each colony was pelleted and washed twice with PBS for 15 minutes. The E. coli was resuspended in 10 μM glucose solution containing 0.01 μCi of ³H-glucose and incubated for about 1 minute to about 15 minutes. The cells were again pelleted, quickly rinsed with 0.5 ml of PBS and replleted. The cells were resuspended in 0.03 ml of PBS, placed in scintillation fluid, and counted. In the first round of screening, mutants having counts 3-fold greater than the lowest detectable signal were eliminated, which removed 96% of the colonies due to strong glucose affinity. In the second round, mutants having counts at the lower limit of detection were selected. These colonies were then examined by SDS-PAGE to confirm overexpression of the mutant GGBP receptors. Colonies that did not express recombinant GGBP were eliminated from further analysis.

### Example 3

### Screening Mutant GGBP Using Radiolabeled Ligand

By randomizing the amino acids at or near ligand H-bonding sites of the GGBP protein, a library of useful protein mutants was generated. Screening of a library is necessary to isolate periplasmic binding receptors having either a specific ligand affinity (e.g., for GGBP, a glucose affinity of 1-20 mM), or a specificity for a non-native ligand (e.g., MBP binding glucose). The present invention provides periplasmic expression screening as a method to enrich bacterial receptors in vivo without the need for protein purification. The reported rapid off-rate (˜10⁻² sec) for ligand binding of PBP's, suggested that ligand dissociation would occur before the bound fraction could be quantified. Thus, in a first round of screening E. coli expressing GGBP having strong glucose affinity were eliminated, then in a second round of screening E. coli that minimally bound glucose were isolated. These isolated variants were then purified and characterized for their ligand affinity.

It was determined that the in vivo periplasmic GGBP could bind glucose and be detected under screening assay conditions. Samples from both induced and non-induced E. coli were challenged with 10 μM glucose/³H-glucose, and washed prior to counting. The results demonstrated that periplasmic GGBP receptors having strong glucose affinity were capable of generating a strong signal as compared to non-induced samples. Thus, during library screening mutants having strong glucose affinity could be eliminated from the population.

### Example 4

### Mutant GGBP Protein Expression and Purification

GGBP protein from the above examples, expressed from E. coli strain Sg13009 following standard protocols (Qiagen) may be further purified. For example, after induction, bacteria were lysed and purified by IMAC using Talon cobalt²⁺ resin (Clontech). The purified protein solution was filtered through 100 kDa and 10 kDa cutoff filters (Millipore). The protein (1-2 mg/ml) was dialyzed at 4° C. into a solution containing 1M NaCl, 10 mM Tris-HCl, and 50 mM NaPO4 (pH 8) and stored at 20° C. The yield from the purification was 10 mg/l and the activity of the protein is stable for at least six months. The selected mutants were expressed, purified, and IANBD-labeled to determine their ability to produce a fluorescent response to 100 mM glucose. Mutant E149C,A213R and E149C,N256R produced a 6- and 2-fold increase in fluorescence on binding glucose, respectively. A binding curve for each mutant was generated and a glucose affinity of 1 mM was determined for E149C,A213R. Mutant E149C,N256R did not reach saturation at 100 mM glucose and had a lower fluorescent response on ligand binding, and therefore was eliminated from further testing. Thus, the screening assay of the instant invention successfully identified the GGBP mutant E149C,A213R binding protein with an affinity for glucose that is the lower limit of physiologically relevant target range of 1-20 mM. Mutant E149C,L238S was identified through an analogous procedure. The mutant binding protein produced a 6-fold increase in fluorescence and possessed a glucose affinity of 0.08 mM, after labeling with IANBD.

Combining the preceding mutations provided E149C,A213R,L238S, a protein with glucose binding affinity that is within the physiological range. This GGBP mutant demonstrated over a 6-fold increase in fluorescence and a glucose binding affinity of 12 mM after labeling with IANBD. As an illustrative example, the stability of this protein's binding activity was determined by storing solutions of the labeled protein at 25° C. and at 37° C. in a dark environment, and testing aliquots periodically for fluorescent response to glucose. The fluorescence increase for E149C,A213R,L238S upon binding glucose retained 92% of the original fluorescence increase after 3 months at 25° C., and 88% after 3 months at 37° C. Relative stability of the protein's tertiary structure was determined using CD (circular dichroism) spectroscopy of the protein in solution. Spectra were collected in 10 mM PBS, pH 7.4. Each spectrum was the average of 3 accumulations. Thermal denaturation was monitored at 220 nm using a temperature slope of 15° C. per hour over a temperature range of 15-75° C. The Tm (temperature where 50% of the protein was denatured) was 47° C. without glucose and 50° C. in the presence of glucose (see FIG. 2).

### Example 5

### Mutagenesis of Maltose Binding Protein

The construction of a MBP cDNA library consisted of eight randomized amino acids associated with the binding pocket of the protein. These amino acid sites are believed to hydrogen-bond to maltose ligand and provide ligand binding specificity. Thus, a plasmid pMAL-MBP was constructed in a manner similar to that disclosed above. The MBP mutants were overexpressed in the Sg13009 strain of E. coli. and a sampling from the library was examined by SDS-PAGE to determine whether MBP was expressed in each sample examined. The Sg13009 strain expresses endogenous MBP and therefore it was necessary to ensure that the mutated MBP would be present at significant levels over wild-type. After an overnight expression, an SDS-PAGE analysis indicated approximately 10-fold greater mutated MBP was expressed in the induced sample. SDS-PAGE data indicated additional lower MW bands are apparent in the randomized MBP. These may be truncated versions of MBP.

### Example 6

### Screening Mutant MBPs Using Labeled Ligand

Maltotetraose (5 mg, 7.5 mmole, Sigma-Aldrich) and BODIPY-FL-hydrazide (7.5 mg, 24.5 mmole, Molecular Probes) were combined in an Eppendorf tube in 200 uL of a 1:1 mixture of DMSO and sodium acetate, pH 5.0. The tube was covered with foil and was mixed gently for three days at room temperature on a Dynal Rotamix. The crude product was purified by size-exclusion chromatography (Sephadex G-10 column, Pharmacia), eluting with PBS, and fractions were analyzed and further purified by reverse phase HPLC (Waters Delta Pak 300 A C18 3.9×150 mm column) with gradient elution of from 88 to 60% 50 mM TEAA (triethylammonium acetate) in acetonitrile over 30 minutes. The conjugate maltotetraose-BODIPY-FL (2) eluted after approximately 20 minutes.

MBP wild-type and mutant library cultures from above were analyzed with the BD FACS Vantage SE. All samples were challenged with the fluorescent conjugate maltotetraose-BODIPY (described above) at a concentrations of 1 μM, 30 μM and 100 μM from 1 minute to about 1 hour at room temperature on a rotating rocker. A non-induced aliquot of the wild-type was used as a control to determine non-specific staining and for making adjustments to instrument settings. The induced wild-type sample served as a positive control sample and provided a useful standard for monitoring sample manipulation and staining steps.

Wild-type MBP (control) was overexpressed in a population of E coli using 1 mM IPTG. Fifty microliters of this culture was challenged with 30 μM fluorescent conjugate maltotetraose-BODIPY (described above) (Kd=1 uM) in 100 μl 5×PBS, for about 1 minute to about 1 hour at room temperature. A high salt buffer (1 M NaCl, 10 mM Tris-HCl and 50 mM NaPO₄ (pH 8)), instead of 5×PBS, may also be used. Approximately 50,000 E coli were analyzed in 1 min. A distinct population (31.7%) of wild-type MBP-expressing E coli was demonstrated to bind the fluorescent conjugate maltotetraose-BODIPY. This is over 6-fold greater than results for the uninduced control sample (4.93%).

Wild-type MBP and the randomized MBP library were analyzed and sorted as follows: a 50 ul aliquot of the induced culture was transferred to a microcentrifuge tube, pelleted by centrifugation, and washed with 5×PBS. Again, the high salt buffer described above may also be used. The samples were pelleted again and resuspended with 950 ul 5×PBS and 50 μl maltotetraose-BODIPY for a final concentration of 100 uM ligand. The high salt buffer may be substituted for 5×PBS. Samples were mixed on a rotating rocker, protected from light, for 1 minute. Samples were transferred to 12×75 mm tubes just prior to analysis on the FACS Vantage.

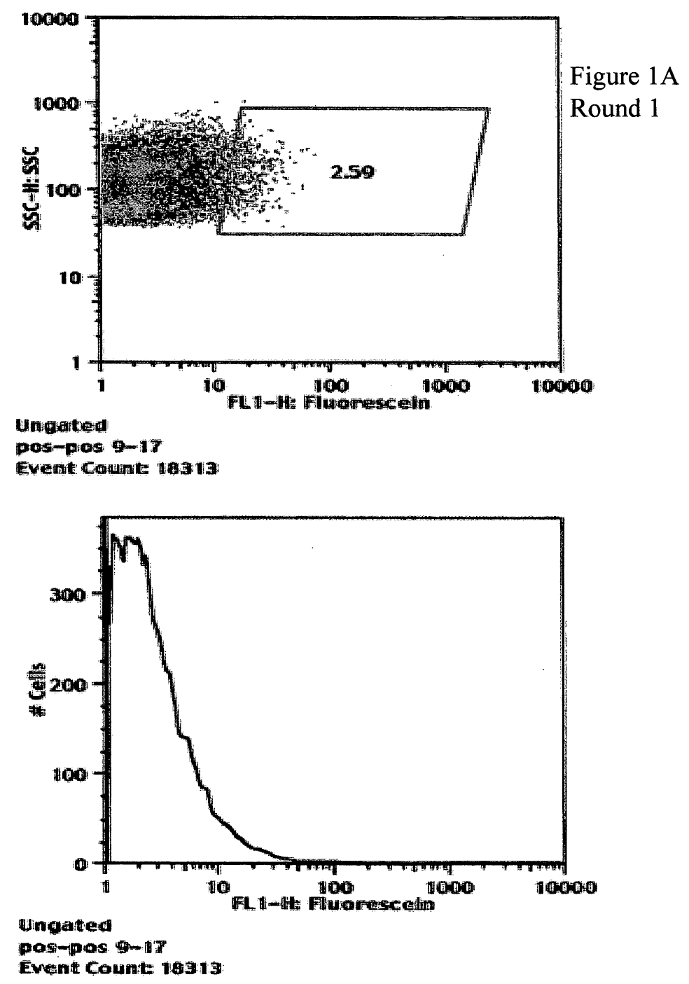

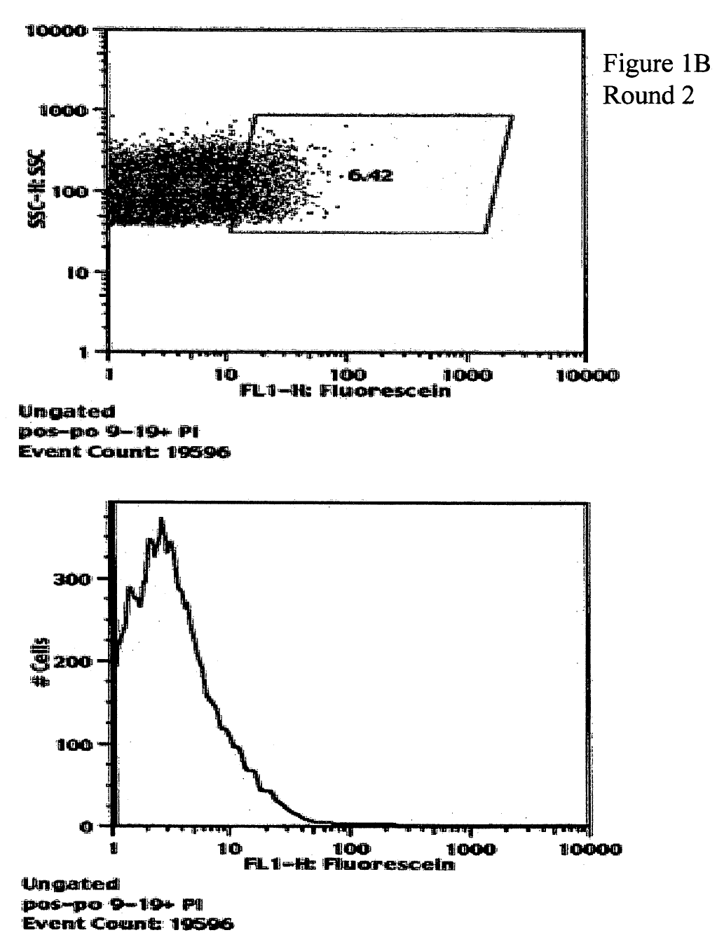

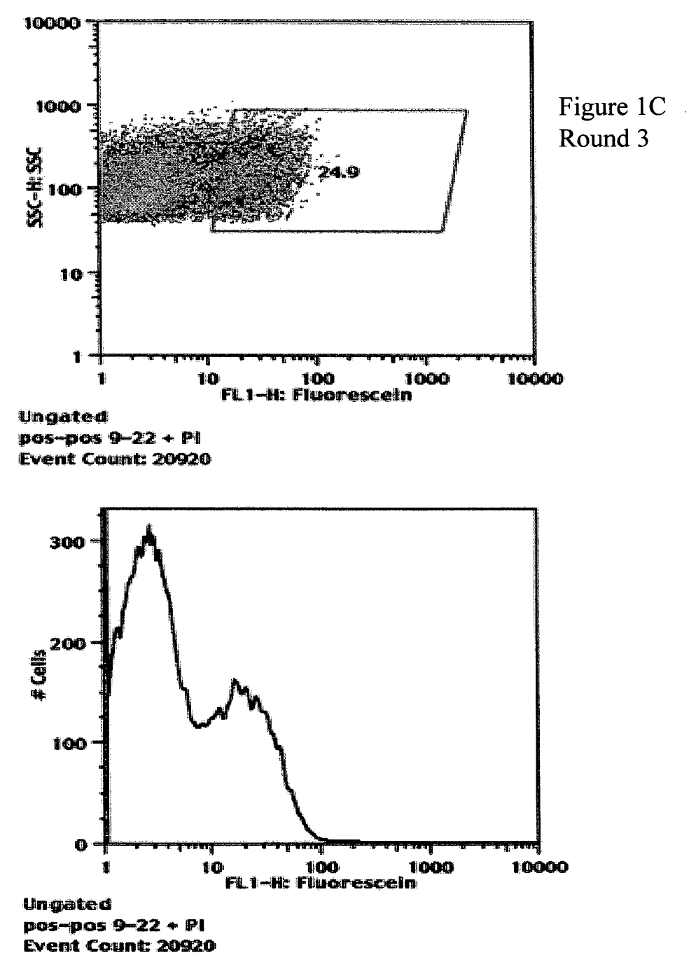

An iterative process was followed to isolate and enrich a select population from within a mixed library culture. This increases the probability of recovering low frequency clones and can be combined with competitive selection to further isolate clones with desired affinity characteristics. For the FACS analysis, uninduced wild-type sample was used to set PMT voltages and gates. Using the mutant library culture for the first round of analysis, 2×10⁶ cells were sorted in Enrich mode. The brightest 2.59% cells were collected and expanded with LB-Kan-Amp media, incubated overnight at 37° C. and protein expression was induced. A second round of staining was performed and a small increase in positive-staining (6.42%) was observed. This population was sorted using the previously established fluorescence gate and regrown overnight. The third round of staining revealed a significant increase in positive staining cells (24.9%), and was used for competitive selection. The FACS analyses for the first round and for the two enriched rounds of cell populations are shown in FIG. 1. Thus, in 3 rounds of sorting/regrowth, a 10-fold enrichment of positive isolates based on binding affinity was achieved.

### Example 7

### Competition Assay to Select for Host Cells Comprising Stable Mutant Binding Proteins with Desired Characteristics

To perform affinity enhancement, the positive population from previous rounds of mutagenesis and screening was expanded overnight and induced for protein expression. The population was probed with labeled maltotetraose as described, washed, and incubated for 60 minutes with 5 mM unlabeled maltose as a competitor. When analyzed by flow, the cells that retained the labeled probe were characterized by their decreased affinity for maltose.

### Example 8

### Mutant MBP Expression and Purification

MBP mutants selected by FACS may be purified and characterized. The clones were expressed from E. coli strain Sg13009 following standard protocols (Qiagen). Briefly, the bacteria containing mutant MBP were lysed and protein was purified using a N-terminal polyhistidine tag with IMAC using Ni-NTA beads (Qiagen). The protein solution was filtered through a 100 kDa filter (Millipore) and then a 10 kDa cutoff filter (Millipore) to concentrate to 1-2 mg/ml. The protein was dialyzed at 4° C. into a solution containing 1 M NaCl, 10 mM Tris-HCl, and 50 mM NaPO₄ (pH 8) and stored at 4° C. These mutants were then dye-labeled and tested for signal generation upon ligand binding.

### Example 9

### Characterization of Selected Clones

For the mutants selected by FACS, a fluorescence assay was used to determine their maltose affinity. The mutants were labeled by fluorophore coupling of N,N′-dimethyl-N-(iodoacetyl)-N′-(7-nitrobenz-2-oxa-1,3-diazol-4-yl)ethylenediamine (IANBD amide, Molecular Probes) to a cysteine site created by mutagenesis at position 95 (Gilardi et al. (1997) Protein Eng. 10(5):479-86). Briefly, purified protein (1-2 mg/ml) was treated with dithiothreitol for 30 min and then a 10-fold molar excess of freshly prepared solution of IANBD was added. The protein and dye were gently mixed at RT for 4 hrs before the unreacted dye was removed by Nap-5 (Amersham) size-exclusion column chromatography. The efficiency of the coupling was determined by absorbance.

Two clones with affinity to carbohydrates were characterized. DNA sequencing confirmed the identity of the selected clones SC 1 and SC2, respectively, as determined by FACS:
SC1=MBP(D14L,K15R,D95C)-NBD
SC2=MBP(D14V, K15V, D95C)-NBD
CONTROL=MBP(D95C)-NBD

As summarized in Table III, the FACS-selected clones SC-1 and SC-2 had altered affinity for native ligands that demonstrates the utility of the instant method. Fluorescent reporter labeled mutant proteins also showed useful changes in fluorescence (QF) upon ligand binding as desired for sensor applications. QF is defined as the ratio of fluorescence intensity in the presence of ligand, divided by the ratio of fluorescence intensity in the absence of ligand.

TABLE III
Characterization of FACS-Selected Clone

| | QF | | Affinity (uM) | | |
|---|---|---|---|---|---|
| Carbohydrate | CONTROL | SC-1 | CONTROL | SC-1 | SC-2 |
| maltoside | 5.5 | 5.5 | | | |
| Maltose | 5.3 | 3.4 | 1 | 15 | 220 |
| maltotetraose | 5.2 | 2.1 | 0.2 | 3.6 | 40 |
| maltotetraitol | 1.2 | 2.8 | 4.5 | 3.7 | 11 |

### Example 10

### Mutant DsRed2-GGBP-acGFP Fusion Constructs for Screening Using FRET Detection

DsRed2-GGBP-acGFP protein fusion was constructed by ligating the DsRed2 gene into the plasmid having the GGBP gene in the pQE70 expression vector. The DsRed2 gene was PCR amplified from pDsRed2_N1 (Clontech). The primer used for the PCR changed the stop codon to an alanine and created a NotI restriction site after the DsRed2 gene (3′ end). The PCR also created an SphI site on the 5′ end of the DsRed2 gene, this placed DsRed2 on the N-terminus of GGBP creating DsRed2_GGBP. To create DsRed2-GGBP-acGFP, the gene for acGFP was placed on the C-terminus of the GGBP. This was done by amplifying the acGFP gene from the plasmid pAcGFP1 (Clontech) and ligating it into the expression plasmid containing DsRed2-GGBP gene. The PCR placed a EcoR1 site on the 5′ end of AcGFP and a BglII site on the 3′ end. After ligation the DsRed2-GGBP-acGFP was DNA sequenced for confirmation of the gene. Thus, the desired plasmid PQE70-DsRed2-GGBP-acGFP was fabricated.

The expression of DsRed2-GGBP-acGFP in E. coli was optimized by first inducing with IPTG and then monitoring the fluorescence produced by the DsRed2 and acGFP proteins. Initially, the protein is expressed for 2-6 hours at 37 C and then transferred to a 25 C shaker for up to 6 days. A 1 ml sample of fermentation broth is removed every 24 hrs during the 25 C expression and examined for fluorescence. The fermentation is concluded when the fluorescence suggests that the DsRed2 has tetramerized. After induction, the E. coli expressing the DsRed2-GGBP-acGFP were dialyzed overnight with high salt buffer (1 M NaCl, 10 mM Tris-HCl and 50 mM NaPO₄ (pH 8)) and then tested for fluorescent response. After accounting for volume displacement, there was a 1-4% increase in DsRed2 emission at 22 mM glucose after excitation at 475 nm due to FRET.

### Example 11

### Mutant DsRed2-MBP-acGFP Fusion Constructs for Screening Using FRET Detection

The fusion protein dsRed2-MBP-acGFP was generated via plasmid encoding. Thus, by PCR-amplifying the MBP gene from pMAL-p2x (New England Biolabs), removing the GGBP gene from the pQE70 plasmid (Qiagen) encoding dsRed2-GGBP-acGFP by restriction digest, and ligating the MBP gene into the pQE70 plasmid in-between the dsRed2 and acGFP genes, the desired plasmid pQE70-dsRed2-MBP-acGFP was fabricated. The methods described are well known and within the skill of the artisan. Isolated clone was DNA sequenced to confirm their identity as pQE70 encoding DsRed2-MBP-acGFP. Transforming the protein expression strain of E. coli (Sg13009) with the plasmids expressed recombinant protein, the recombinant protein was purified using the C-terminal His-tag.

The recombinant proteins DsRed2-MBP-acGFP or DsRed2-GGBP-acGFP may have any suitable linker sequence between the DsRed2 and PBP protein portions as is necessary for FRET optimization. For example, the linker sequence between the DsRed2 and MBP protein portions may be the sequence Ala-Ala-Ala-Ala-Ala-Leu-Ala between DsRed2 and MBP protein, with approximately 25 residues between MBP and acGFP.

It is understood that the increased complexity of these PBP fusion constructs may require longer maturation times than needed for DsRed2-PBP fusions, and that in general, longer maturation times may be needed because of DsRed2 tetramer formation. It is also understood that the present invention encompasses DsRed variants with shorter maturation times irrespective of the likelihood that these proteins are much dimmer fluorophores. It is also understood that such DsRed variants include DsRed monomers.

### Example 12

### Mutant pQE70-DsRed2-GGBP Construct Having One Fluorescent Protein for Screening Using FRET Detection

Plasmid pTZ18R containing the MgLB periplasmic binding protein (GGBP) gene from E. coli strain JM109 was used. The GGBP PBP gene was amplified from pTZ18R plasmid. The GGBP PBP gene was ligated into a pQE70 plasmid to create a histidine-tagged protein that was wild-type in sequence, except for a lysine-to-arginine change at amino acid position 309, and the addition of a serine at amino acid position 310, before the six histidines at the C-terminus. The fluorescent protein gene (e.g., from Discosoma sp., hereinafter DsRed2) was amplified from (pDsRed2) and ligated to the N-terminus of the GGBP gene. A linker was engineered into the construct between the fluorescent protein and the histidine-tagged PBP. Thus, the plasmid for the pQE70-DsRed2-GGBP fusion construct was fabricated.

### Example 13

### Mutant pQE70-DsRed2-MBP Construct Having One Fluorescent Protein for Screening Using FRET Detection

In a manner similar to the plasmid construct for the DsRed2-GGBP, the plasmid pQE70-DsRed2-MBP may be constructed. Mutations of the PBP and/or the fluorescent protein as described above and hereinafter are generated in the construct by standard methods. PCR may be performed using primers that substitute codon(s) at or near the primary native ligand contact sites or knockout native cysteines of the DsRed2. For example, it may be advantageous to remove the cysteine residue from the DsRed2 portion of the fusion so that if the fusion was fluorophore labeled, the label will be site-specifically conjugated to the PBP only. For example, plasmids representing mutated DsRed2 (C119A) for the GGBP fusion were constructed. SEQ ID NO: 9 shows the polynucleotide sequence of a fusion protein between mutated dsRed2 and wild-type GGBP. In a similar manner, plasmid representing mutated DsRed2 (C119A) for the MBP fusion may be constructed. SEQ ID NO: 10 shows the polynucleotide sequence of a fusion protein between mutated dsRed2 and wild-type MBP. PBP proteins are preferably coded with histidine tags for ease of purification, however, the absence of histidine tags for the PBP fusions are within the scope of the present invention.

### Example 14

### Purification of Fusion Protein Comprising Mutant PBP and DsRed2

The PBP may be expressed from E. coli strain Sg13009. After E. coli induction for 72 hours, the bacteria may be lysed. The lysate may be cleared by centrifugation and the DsRed2-PBP fusion protein purified by immobilized metal affinitive chromatography (IMAC) using Talon (cobalt-based) Resin from Clontech. The fusion protein may be concentrated using a 100 kDa cutoff filter. The protein may then be dialyzed at 4° C. into a solution containing 1M NaCl, 10 mM Tris-HCl, and 50 mM NaPO4 (pH 8) and stored at 20° C.

### Example 15

### Host Cell Screening of Mutant PBP—Fusion Constructs by FACS

Wild-type PBP may be overexpressed in populations of E coli using 1 mM IPTG. Fifty microliters of culture would be exposed to about 30 μM fluorescently labeled ligand in 100 μl high salt buffer (1 M NaCl, 10 mM Tris-HCl and 50 mM NaPO₄ (pH 8)) for about 1 minute to about 1 hr at room temperature. Approximately 50,000 E coli can be analyzed in about 1 min. A distinct population of PBP-expressing E coli is expected to bind the labeled ligand. This may be determined by FACS signal over 2-fold greater than results for a uninduced control sample.

Wild-type PBP and the randomized PBP library is analyzed and sorted as follows: a 50 ul aliquot of the induced culture is transferred to a microcentrifuge tube, pelleted by centrifugation, and washed with high salt buffer (1 M NaCl, 10 mM Tris-HCl and 50 mM NaPO₄ (pH 8)). The samples are pelleted again and resuspended with 950 ul high salt buffer (1 M NaCl, 10 mM Tris-HCl and 50 mM NaPO₄ (pH 8)) and 50 ul labeled ligand for a final concentration of 100 uM ligand. Samples are mixed on a rotating rocker, protected from light, for about 1 minute to about 1 hour. Samples are then be transferred to 12×75 mm tubes just prior to analysis on the FACS Vantage.

An iterative process would be followed to isolate and enrich a select population from within a mixed library culture. This increases the probability of recovering low frequency clones and can be combined with competitive selection to further isolate clones with desired affinity characteristics. For FACS analysis, the uninduced wild-type sample is used to set PMT voltages and gates. Using the mutant library culture for the first round of analysis, about 2×10⁶ cells can be sorted in Enrich mode. The brightest cells would be collected and expanded with LB-Kan-Amp media and incubated overnight at 37° C. A second round of staining can be performed and a small increase in positive-staining would be expected. This population can then be sorted using the previously established fluorescence gate and regrown overnight. The third round of staining should provide a significant increase in positive staining cells and is used for competitive selection. Thus, in three rounds of sorting/regrowth, enrichment of positive isolates based on binding affinity may be achieved.

### Example 16

### Construction of a Fusion Protein Construct for Yeast Cells

A cassette may be constructed by using an enhanced cyan fluorescent protein (ECFP) PCR product followed by a linker and an enhanced yellow fluorescent protein (EYFP) PCR product (CLONTECH). A truncated malE PCR product encoding mature maltose-binding protein (MBP) without N-terminal signal peptide (position 79-1188 relative to the ATG) may then be fused between the two GFP genes. Then, the chimeric fragment may be inserted into pRSET (Invitrogen) and yeast expression vector pDR195, as described by Rentsch et al., (1995) FEBS Lett. 370, 264-268, and transferred into E. coli BL21 (DE3) Gold (Stratagene), Saccharomyces cerevisiae SuSy7/ura3 expressing StSUT1 (Barker et al., (2000) Plant Cell 12, 1153-1164) and EBY 4000 (Wieczorke et al., (1999) FEBS Lett. 464, 123-128). The desired malE mutations may be generated by using the QuikChange kit (Stratagene).

Expression and Enrichment of Yeast Cells Containing PBP Fusion Proteins: BL21 (DE3) Gold would be grown for about 2 days at 21° C. in the dark. Saturation of the cells with ligand would be performed overnight at about 37° C. Cells may be sorted by FACS. Any PBP fusion proteins of interest may be purified by resuspended in 20 mM TrisCl, pH 7.9, and disrupted by ultrasonication followed by His-Bind affinity chromatography (Novagen).

### Example 17

### Construction of a Fusion Protein Construct for Mammalian Cells

By way of example, to express the fusion protein dsRed2-PBP-acGFP gene in mammalian cells, the fusion gene may be cloned into a plasmid such as pQE-TriSystem (Qiagen) that enables protein expression in mammalian cells. A strong constitutive CAG promoter (CMV/actin/globin) promoter mediates transient mammalian expression from this vector. Other mammalian expression vectors such as pAdVAntage and pCI (Promega) or pCMV-Script and pDual (Stratagene) are available and may be used, the choice of any particular vector being within the skill of the art.

The methods of mammalian expression described herein are well known and within the skill of the artisan. Isolated mammalian expression plasmid DNA having the dsRed2-PBP-acGFP gene may be transfected into mammalian cells. Typical cells lines that may be used are HeLa, 293, or COS-7 cells which can be transforming using calcium phosphate precipitation or lipofection.

The cells in the population that acquire DNA would transiently express the encoded protein over a period of days or weeks. The cells may then be examined and or sorted by FACS via FRET upon ligand binding.

It is also within the spirit and scope of the instant invention that methods for screening PBP's expressed in host cells may be performed, for example, at different temperatures, pH, or buffer solutions, with such modifications to the screening being limited only by the host cell's viability in the particular conditions of the screening.

### BRIEF DESCRIPTION OF THE SEQUENCE LISTING

This application contains a sequence listing for SEQ ID NOs: 1-12, which are hereby incorporated by reference.

SEQ ID NO:1 depicts a polynucleotide sequence comprising the sequence of the fusion protein dsRed2-GGBP-acGFP, with the GGBP sequence being the wild-type sequence from E. coli.

SEQ ID NO:2 depicts a polynucleotide sequence comprising the sequence of the fusion protein dsRed2-MBP-acGFP, with the MBP sequence being the wild-type sequence from E. coli.

SEQ ID NO:3 depicts a polynucleotide sequence comprising the sequence of the fusion protein dsRed2-GGBP, with the GGBP sequence being the wild-type sequence from E. coli.

SEQ ID NO:4 depicts a polynucleotide sequence comprising the sequence of the fusion protein dsRed2-MBP, with the MBP sequence being the wild-type sequence from E. coli.

SEQ ID NO:5 depicts the coding sequence of the wild-type GGBP protein.

SEQ ID NO:6 depicts the coding sequence of the wild-type MBP protein.

SEQ ID NO:7 depicts a polynucleotide sequence comprising the sequence of the fusion protein dsRed-GGBP-acGFP, comprising codons that randomize the polynucleotide sequence of the wild-type GGBP.

SEQ ID NO:8 depicts a polynucleotide sequence comprising the sequence of the fusion protein dsRed-MBP-acGFP, comprising codons that randomize the polynucleotide sequence of the wild-type MBP.

SEQ ID NO:9 depicts a polynucleotide sequence comprising the sequence of the fusion protein dsRed-GGBP, comprising codons that randomize the polynucleotide sequence of the wild-type GGBP.

SEQ ID NO:10 depicts a polynucleotide sequence comprising the sequence of the fusion protein dsRed-MBP, comprising codons that randomize the polynucleotide sequence of the wild-type MBP.

SEQ ID NO:11 depicts a polynucleotide sequence comprising the sequence of the fusion protein dsRed-GGBP, where the coding sequence of the dsRed protein comprises at least one mutation to remove cysteines at, for example, amino acid position 117. The coding sequence of the GGBP protein is that of the wild-type sequence.

SEQ ID NO:12 depicts a polynucleotide sequence comprising the sequence of the fusion protein dsRed-MBP, where the coding sequence of the dsRed protein comprises at least one mutation to remove cysteines at, for example, amino acid position 117. The coding sequence of the MBP protein is that of the wild-type sequence.

What is claimed is:

1. A method of isolating stable mutant binding proteins from a protein library of mutant proteins, said method comprising
a) culturing host cells under conditions suitable for protein expression, said host cells comprising collectively a set of expression vectors, wherein said set of expression vectors comprises collectively polynucleotides encoding at least one member of a protein library of mutant binding proteins;
b) contacting said cultured host cells with at least one ligand;
c) detecting differences in an interaction among individual host cells with said ligand, said differences in interaction of said individual host cells with said ligand indicating differences in said mutant protein stability and in the ability of said at least one expressed mutant binding protein within said individual host cells to interact with said ligand; and
d) separating said individual host cells displaying the desired interaction with said ligand from said individual host cells that do not display the desired interaction with said ligand.

2. The method of claim 1, wherein said mutant binding proteins are mutants of periplasmic binding proteins (PBPs).

3. The method of claim 2, wherein said PBP is selected from the group consisting of maltose binding protein (MBP) and glucose-galactose binding protein (GGBP).

4. The method of claim 1, wherein said mutant protein library is not a phage display library.

5. The method of claim 4, wherein the amino acid sequences of said members of said mutant protein library are at least about 95% identical to a wild-type protein.

6. The method of claim 4, wherein said ligand is labeled.

7. The method of claim 6, wherein said label is a fluorescent label such that said detecting detects the presence or absence of said fuorescent label.

8. The method of claim 7, wherein said individual cells are not lysed during said detection and said separation.

9. The method of claim 8, wherein said detection and separation of said individual cells is accomplished through fluorescence activated cell sorting (FACS).

10. The method of claim 1, wherein said mutant binding proteins are fusion proteins.

11. A method of isolating at least one polynucleotide encoding a stable mutant binding protein, said method comprising
a) culturing host cells under conditions suitable for protein expression, said host cells comprising collectively a set of expression vectors, wherein said set of expression vectors comprises collectively polynucleotides encoding at least one member of a protein library of mutant binding proteins;
b) contacting said cultured host cells with at least one ligand;
c) detecting differences in an interaction among individual host cells with said ligand, said differences in interaction of said individual host cells with said ligand indicating differences in said mutant protein stability and in the ability of said at least one expressed mutant binding protein within said individual host cells to interact with said ligand;
d) separating said individual host cells displaying the desired interaction with said ligand from said individual host cells that do not display the desired interaction with said ligand; and
e) separating the expression vector from said individual host cells displaying said desired interaction, said expression vector comprising the polynucleotide encoding said stable mutant binding protein capable of specifically binding said ligand.

12. The method of claim 11, wherein said mutant binding proteins are mutants of periplasmic binding proteins (PBPs).

13. The method of claim 12, wherein said PBP is selected from the group consisting of maltose binding protein (MBP) and glucose-galactose binding protein (GGBP).

14. The method of claim 11, wherein said mutant protein library is not a phage display library.

15. The method of claim 14, wherein the amino acid sequences of said members of said mutant protein library are at least about 95% identical to the wild-type protein.

16. The method of claim 14, wherein said ligand is labeled.

17. The method of claim 16, wherein said label is a fluorescent label such that said detecting detects the presence or absence of said fluorescent label.

18. The method of claim 17, wherein said individual cells are not lysed during said detection and said separation.

19. The method of claim 18, wherein said detection and separation of said individual cells is accomplished through fluorescence activated cell sorting (FACS).

20. The method of claim 11, wherein said mutant binding proteins are fusion proteins.

21. A method of generating at least one stable mutant binding protein with desired properties, said method comprising
a) culturing host cells under conditions suitable for protein expression, said host cells comprising collectively a set of expression vectors, wherein said set of expression vectors comprises collectively polynucleotides encoding at least one member of a protein library of mutant binding proteins;
b) contacting said cultured host cells with at least one ligand;
c) detecting differences in an interaction among individual host cells with said ligand, said differences in interaction of said individual host cells with said ligand indicating differences in said mutant protein stability and in the ability of said at least one expressed mutant binding protein within said individual host cells to interact with said ligand;
d) separating said individual host cells displaying the desired interaction with said ligand from said individual host cells that do not display the desired interaction with said ligand;
e) isolating the expression vector from said individual host cells displaying said desired interaction, said expression vector comprising a polynucleotide encoding a stable mutant binding protein capable of specifically binding said ligand;
f) generating a subsequent mutant protein library of said stable mutant binding protein in (e), said generation of said subsequent mutant library comprising targeted random mutagenesis of said polynucleotide encoding said first stable mutant binding protein from (e) to produce said subsequent mutant protein library; and
g) repeating (a) through (e) on said subsequent mutant protein library either to obtain additional subsequent mutant protein library or libraries or to obtain a polynucleotide encoding said stable mutant protein with said desired properties; said additional subsequent library or libraries being subjected to (a) through (e) until said polynucleotide encoding said stable mutant protein with said desired properties is obtained.

22. The method of claim 21, wherein said mutant binding proteins are mutants of periplasmic binding proteins (PBPs).

23. The method of claim 22, wherein said PBP is selected from the group consisting of maltose binding protein (MBP) and glucose-galactose binding protein (GGBP).

24. The method of claim 21, wherein said mutant protein library is not a phage display library.

25. The method of claim 24, wherein the amino acid sequences of said members of said mutant protein library are at least about 95% identical to the wild-type protein.

26. The method of claim 24, wherein said ligand is labeled.

27. The method of claim 26, wherein said label is a fluorescent label such that said detecting detects the presence or absence of said fluorescent label.

28. The method of claim 27, wherein said individual cells are not lysed during said detection and said separation.

29. The method of claim 28, wherein said detection and separation of said individual cells is accomplished through fluorescence activated cell sorting (FACS).

30. The method of claim 21, wherein said mutant binding proteins are fusion proteins.

31. A polynucleotide comprising a mutant polynucleotide sequence at least 95% identical to a polynucleotide sequence selected from the group consisting of SEQ ID NO:1, SEQ ID NO:2, SEQ ID NO:3 and SEQ ID NO:4.

32. The polynucleotide of claim 31, wherein said polynucleotide comprises the polynucleotide sequence selected from the group consisting of SEQ ID NO:7, SEQ ID NO:8, SEQ ID NO:9 and SEQ ID NO:10.

33. A vector comprising the polynucleotide of claim 31.

34. A host cell comprising the vector of claim 33.

35. A method of making a protein, said method comprising culturing the host cell of claim 34 under conditions suitable for protein expression.


SEQUENCE LISTING (12 sequences)

SEQ ID NO: 1 - DNA, 2361 bp, Artificial
  polynucleotide sequence encoding fusion protein dsRed2-GGBP-acGFP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccgtgggctgggaggcctccaccgagcgcctgtacccccgcgacggcgtgctgaagggcgagacccacaaggccctgaagctgaaggacggcggccactacctggtggagttcaagtccatctacgcggccaagaagcccgtgcagctgcccggctactactacgtggacgccaagctggacatcacctcccacaacgaggactacaccatcgtggagcagtacgagcgcaccgagggccgccaccacctgttcctggcagcggccgctgatactcgcattggtgtaacaatctataagtacgacgataactttatgtctgtagtgcgcaaggctattgagcaagatgcgaaagccgcgccagatgttcagctgctgatgaatgattctcagaatgaccagtccaagcagaacgatcagatcgacgtattgctggcgaaaggggtgaaggcactggcaatcaacctggttgacccggcagctgcgggtacggtgattgagaaagcgcgtgggcaaaacgtgccggtggttttcttcaacaaagaaccgtctcgtaaggcgctggatagctacgacaaagcctactacgttggcactgactccaaagagtccggcattattcaaggcgatttgattgctaaacactgggcggcgaatcagggttgggatctgaacaaagacggtcagattcagttcgtactgctgaaaggtgaaccgggccatccggatgcagaagcacgtaccacttacgtgattaaagaattgaacgataaaggcatcaaaactgaacagttacagttagataccgcaatgtgggacaccgctcaggcgaaagataagatggacgcctggctgtctggcccgaacgccaacaaaatcgaagtggttatcgccaacaacgatgcgatggcaatgggcgcggttgaagcgctgaaagcacacaacaagtccagcattccggtgtttggcgtcgatgcgctgccagaagcgctggcgctggtgaaatccggtgcactggcgggcaccgtactgaacgatgctaacaaccaggcgaaagcgacctttgatctggcgaaaaacctggccgatggtaaaggtgcggctgatggcaccaactggaaaatcgacaacaaagtggtccgcgtaccttatgttggcgtagataaagacaacctggctgaattcgccaccgcggtgagcaagggcgccgagctgttcaccggcatcgtgcccatcctgatcgagctgaatggcgatgtgaatggccacaagttcagcgtgagcggcgagggcgagggcgatgccacctacggcaagctgaccctgaagttcatctgcaccaccggcaagctgcctgtgccctggcccaccctggtgaccaccctgagctacggcgtgcagtgcttctcacgctaccccgatcacatgaagcagcacgacttcttcaagagcgccatgcctgagggctacatccaggagcgcaccatcttcttcgaggatgacggcaactacaagtcgcgcgccgaggtgaagttcgagggcgataccctggtgaatcgcatcgagctgaccggcaccgatttcaaggaggatggcaacatcctgggcaataagatggagtacaactacaacgcccacaatgtgtacatcatgaccgacaaggccaagaatggcatcaaggtgaacttcaagatccgccacaacatcgaggatggcagcgtgcagctggccgaccactaccagcagaatacccccatcggcgatggccctgtgctgctgcccgataaccactacctgtccacccagagcgccctgtccaaggaccccaacgagaagcgcgatcacatgatctacttcggcttcgtgaccgccgccgccatcacccacggcatggatgagctgtacaagtccggactcagatctcatcaccatcaccatcactaa

SEQ ID NO: 2 - DNA, 2625 bp, Artificial
  polynucleotide sequence encoding fusion protein dsRed2-MBP-acGFP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccgtgggctgggaggcctccaccgagcgcctgtacccccgcgacggcgtgctgaagggcgagacccacaaggccctgaagctgaaggacggcggccactacctggtggagttcaagtccatctacgcggccaagaagcccgtgcagctgcccggctactactacgtggacgccaagctggacatcacctcccacaacgaggactacaccatcgtggagcagtacgagcgcaccgagggccgccaccacctgttcctggcagcggccgcggctattgctaaaatcgaagaaggtaaactggtaatctggattaacggcgataaaggctataacggtctcgctgaagtcggtaagaaattcgagaaagataccggaattaaagtcaccgttgagcatccggataaactggaagagaaattcccacaggttgcggcaactggcgatggccctgacattatcttctgggcacacgaccgctttggtggctacgctcaatctggcctgttggctgaaatcaccccggacaaagcgttccaggacaagctgtatccgtttacctgggatgccgtacgttacaacggcaagctgattgcttacccgatcgctgttgaagcgttatcgctgatttataacaaagatctgctgccgaacccgccaaaaacctgggaagagatcccggcgctggataaagaactgaaagcgaaaggtaagagcgcgctgatgttcaacctgcaagaaccgtacttcacctggccgctgattgctgctgacgggggttatgcgttcaagtatgaaaacggcaagtacgacattaaagacgtgggcgtggataacgctggcgcgaaagcgggtctgaccttcctggttgacctgattaaaaacaaacacatgaatgcagacaccgattactccatcgcagaagctgcctttaataaaggcgaaacagcgatgaccatcaacggcccgtgggcatggtccaacatcgacaccagcaaagtgaattatggtgtaacggtactgccgaccttcaagggtcaaccatccaaaccgttcgttggcgtgctgagcgcaggtattaacgccgccagtccgaacaaagagctggcaaaagagttcctcgaaaactatctgctgactgatgaaggtctggaagcggttaataaagacaaaccgctgggtgccgtagcgctgaagtcttacgaggaagagttggcgaaagatccacgtattgccgccactatggaaaacgcccagaaaggtgaaatcatgccgaacatcccgcagatgtccgctttctggtatgccgtgcgtactgcggtgatcaacgccgccagcggtcgtcagactgtcgatgaagccctgaaagacgcgcagactaattcgagctcgaacaacaacaacaataacaataacaacaacctcgggatcgagggaagggtgtcagaattcgccaccgcggtgagcaagggcgccgagctgttcaccggcatcgtgcccatcctgatcgagctgaatggcgatgtgaatggccacaagttcagcgtgagcggcgagggcgagggcgatgccacctacggcaagctgaccctgaagttcatctgcaccaccggcaagctgcctgtgccctggcccaccctggtgaccaccctgagctacggcgtgcagtgcttctcacgctaccccgatcacatgaagcagcacgacttcttcaagagcgccatgcctgagggctacatccaggagcgcaccatcttcttcgaggatgacggcaactacaagtcgcgcgccgaggtgaagttcgagggcgataccctggtgaatcgcatcgagctgaccggcaccgatttcaaggaggatggcaacatcctgggcaataagatggagtacaactacaacgcccacaatgtgtacatcatgaccgacaaggccaagaatggcatcaaggtgaacttcaagatccgccacaacatcgaggatggcagcgtgcagctggccgaccactaccagcagaatacccccatcggcgatggccctgtgctgctgcccgataaccactacctgtccacccagagcgccctgtccaaggaccccaacgagaagcgcgatcacatgatctacttcggcttcgtgaccgccgccgccatcacccacggcatggatgagctgtacaagtccggactcagatctcatcaccatcaccatcactaa

SEQ ID NO: 3 - DNA, 1635 bp, Artificial
  polynucleotide sequence encoding fusion protein dsRed2-GGBP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccatgggctgggaggcctccaccgagcgcctgtacccccgcgacggcgtgctgaagggcgagacccacaaggccctgaagctgaaggacggcggccactacctggtggagttcaagtccatctacatggccaagaagcccgtgcagctgcccggctactactacgtggacgccaagctggacatcacctcccacaacgaggactacaccatcgtggagcagtacgagcgcaccgagggccgccaccacctgttcctggcagcggccgctgatactcgcattggtgtaacaatctataagtacgacgataactttatgtctgtagtgcgcaaggctattgagcaagatgcgaaagccgcgccagatgttcagctgctgatgaatgattctcagaatgaccagtccaagcagaacgatcagatcgacgtattgctggcgaaaggggtgaaggcactggcaatcaacctggttgacccggcagctgcgggtacggtgattgagaaagcgcgtgggcaaaacgtgccggtggttttcttcaacaaagaaccgtctcgtaaggcgctggatagctacgacaaagcctactacgttggcactgactccaaagagtccggcattattcaaggcgatttgattgctaaacactgggcggcgaatcagggttgggatctgaacaaagacggtcagattcagttcgtactgctgaaaggtgaaccgggccatccggatgcagaagcacgtaccacttacgtgattaaagaattgaacgataaaggcatcaaaactgaacagttacagttagataccgcaatgtgggacaccgctcaggcgaaagataagatggacgcctggctgtctggcccgaacgccaacaaaatcgaagtggttatcgccaacaacgatgcgatggcaatgggcgcggttgaagcgctgaaagcacacaacaagtccagcattccggtgtttggcgtcgatgcgctgccagaagcgctggcgctggtgaaatccggtgcactggcgggcaccgtactgaacgatgctaacaaccaggcgaaagcgacctttgatctggcgaaaaacctggccgatggtaaaggtgcggctgatggcaccaactggaaaatcgacaacaaagtggtccgcgtaccttatgttggcgtagataaagacaacctggctgaattcagcaagagatctcatcaccatcaccatcactaa

SEQ ID NO: 4 - DNA, 1815 bp, Artificial
  polynucleotide sequence encoding fusion protein dsRed2-MBP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccgtgggctgggaggcctccaccgagcgcctgtacccccgcgacggcgtgctgaagggcgagacccacaaggccctgaagctgaaggacggcggccactacctggtggagttcaagtccatctacgcggccaagaagcccgtgcagctgcccggctactactacgtggacgccaagctggacatcacctcccacaacgaggactacaccatcgtggagcagtacgagcgcaccgagggccgccaccacctgttcctggcagcggccgcggctattgctaaaatcgaagaaggtaaactggtaatctggattaacggcgataaaggctataacggtctcgctgaagtcggtaagaaattcgagaaagataccggaattaaagtcaccgttgagcatccggataaactggaagagaaattcccacaggttgcggcaactggcgatggccctgacattatcttctgggcacacgaccgctttggtggctacgctcaatctggcctgttggctgaaatcaccccggacaaagcgttccaggacaagctgtatccgtttacctgggatgccgtacgttacaacggcaagctgattgcttacccgatcgctgttgaagcgttatcgctgatttataacaaagatctgctgccgaacccgccaaaaacctgggaagagatcccggcgctggataaagaactgaaagcgaaaggtaagagcgcgctgatgttcaacctgcaagaaccgtacttcacctggccgctgattgctgctgacgggggttatgcgttcaagtatgaaaacggcaagtacgacattaaagacgtgggcgtggataacgctggcgcgaaagcgggtctgaccttcctggttgacctgattaaaaacaaacacatgaatgcagacaccgattactccatcgcagaagctgcctttaataaaggcgaaacagcgatgaccatcaacggcccgtgggcatggtccaacatcgacaccagcaaagtgaattatggtgtaacggtactgccgaccttcaagggtcaaccatccaaaccgttcgttggcgtgctgagcgcaggtattaacgccgccagtccgaacaaagagctggcaaaagagttcctcgaaaactatctgctgactgatgaaggtctggaagcggttaataaagacaaaccgctgggtgccgtagcgctgaagtcttacgaggaagagttggcgaaagatccacgtattgccgccactatggaaaacgcccagaaaggtgaaatcatgccgaacatcccgcagatgtccgctttctggtatgccgtgcgtactgcggtgatcaacgccgccagcggtcgtcagactgtcgatgaagccctgaaagacgcgcagactcatcaccatcaccatcactaa

SEQ ID NO: 5 - DNA, 1021 bp, Artificial
  polynucleotide sequence encoding wild-type GGBP protein
atgcataagaaggtgttaaccctgtctgctgtgatggccagcatgttattcggtgccgctgcacacgctgctgatactcgcattggtgtaacaatctataagtacgacgataactttatgtctgtagtgcgcaaggctattgagcaagatgcgaaagccgcgccagatgttcagctgctgatgaatgattctcagaatgaccagtccaagcagaacgatcagatcgacgtattgctggccaagggggtgaaggcactggccatcaacctggttgacccggcagctgcgggtacggtgattgagaaagcgcgtgggcaaaacgtgccggtggttttcttcaacaaagaaccgtctcgtaaggcgctggatagctacgacaaagcctactacgttggcactgactcaaaagagtccggcattattcaaggcgatttgattgctaaacactgggcggcgaatcagggttgggatctgaacaaagacggtcagattcagttcgtactgctgaaaggtgaaccgggccatccggatgcagaagcacgtaccacttacgtgattaaagaattgaacgataaaggcatcaaaactgaacagttacagttagataccgcaatgtgggacaccgctcaggcgaaagataagatggacgcctggctgtctggcccgaacgccaacaaaatcgaagtggttatcgccaacaacgatgcgatggcaatgggcgcggttgaagcgctgaaagcacacaacaagtccagcattccggtgtttggcgtcgatgcgctgccagaagcgctggcgctggtgaaatccggtgcactggcgggcaccgtactgaacgatgctaacaaccaggcgaaagcgacctttgatctggcgaaaaacctggccgatggtaaaggtgcggctgatggcaccaactggaaaatcgacaacaaagtggtccgcgtaccttatgttggcgtagataaagacaacctggctgaattcagcaagagatctcatcaccatcaccatcactaaa

SEQ ID NO: 6 - DNA, 1197 bp, Artificial
  polynucleotide encoding wild-type MBP protein
atgaaaataaaaacaggtgcacgcatcctcgcattatccgcattaacgacgatgatgttttccgcctcggctctcgccaaaatcgaagaaggtaaactggtaatctggattaacggcgataaaggctataacggtctcgctgaagtcggtaagaaattcgagaaagataccggaattaaagtcaccgttgagcatccggataaactggaagagaaattcccacaggttgcggcaactggcgatggccctgacattatcttctgggcacacgaccgctttggtggctacgctcaatctggcctgttggctgaaatcaccccggacaaagcgttccaggacaagctgtatccgtttacctgggatgccgtacgttacaacggcaagctgattgcttacccgatcgctgttgaagcgttatcgctgatttataacaaagatctgctgccgaacccgccaaaaacctgggaagagatcccggcgctggataaagaactgaaagcgaaaggtaagagcgcgctgatgttcaacctgcaagaaccgtacttcacctggccgctgattgctgctgacgggggttatgcgttcaagtatgaaaacggcaagtacgacattaaagacgtgggcgtggataacgctggcgcgaaagcgggtctgaccttcctggttgacctgattaaaaacaaacacatgaatgcagacaccgattactccatcgcagaagctgcctttaataaaggcgaaacagcgatgaccatcaacggcccgtgggcatggtccaacatcgacaccagcaaagtgaattatggtgtaacggtactgccgaccttcaagggtcaaccatccaaaccgttcgttggcgtgctgagcgcaggtattaacgccgccagtccgaacaaagagctggcaaaagagttcctcgaaaactatctgctgactgatgaaggtctggaagcggttaataaagacaaaccgctgggtgccgtagcgctgaagtcttacgaggaagagttggcgaaagatccacgtattgccgccactatggaaaacgcccagaaaggtgaaatcatgccgaacatcccgcagatgtccgctttctggtatgccgtgcgtactgcggtgatcaacgccgccagcggtcgtcagactgtcgatgaagccctgaaagacgcgcagactcaccatcaccatcaccattaa

SEQ ID NO: 7 - DNA, 2361 bp, Artificial
  polynucleotide sequence encoding fusion protein dsRed-GGBP-acGFP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccgtgggctgggaggcctccaccgagcgcctgtacccccgcgacggcgtgctgaagggcgagacccacaaggccctgaagctgaaggacggcggccactacctggtggagttcaagtccatctacgcggccaagaagcccgtgcagctgcccggctactactacgtggacgccaagctggacatcacctcccacaacgaggactacaccatcgtggagcagtacgagcgcaccgagggccgccaccacctgttcctggcagcggccgctgatactcgcattggtgtaacaatcddkaagtacgacddkaacddkatgtctgtagtgcgcaaggctattgagcaagatgcgaaagccgcgccagatgttcagctgctgatgaatgattctcagaatgaccagtccaagcagaacgatcagatcgacgtattgctggccaagggggtgaaggcactggccatcaacctggttgacccggcagctgcgggtacggtgattgagaaagcgcgtgggcaaaacgtgccggtggttttcttcddkddkgaaccgtctcgtaaggcgctggatagctacgacaaagcctactacgttddkddkgacddkaaagagtccggcattattcaaggcgatttgattgctaaacactgggcggcgaatcagggttgggatctgaacaaagacggtcagattcagttcgtactgctgaaaggtgaaccgggcddkccgddkgcagaagcaddkaccacttacgtgattaaagaattgaacgataaaggcatcaaaactgaacagttacagttagataccgcaatgtgggacaccgctcaggcgaaagataagatggacgcctggctgtctggcccgaacgccaacaaaatcgaagtggttatcgccddkddkgatddkatggcaatgggcgcggttgaagcgctgaaagcacacaacaagtccagcattccggtgtttggcddkddkgcgddkccagaagcgctggcgctggtgaaatccggtgcactggcgggcaccgtactgddkgatgctaacaacddkgcgaaagcgacctttgatctggcgaaaaacctggccgatggtaaaggtgcggctgatggcaccaactggaaaatcgacaacaaagtggtccgcgtaccttatgttggcgtagataaagacaacctggctgaattcgccaccgcggtgagcaagggcgccgagctgttcaccggcatcgtgcccatcctgatcgagctgaatggcgatgtgaatggccacaagttcagcgtgagcggcgagggcgagggcgatgccacctacggcaagctgaccctgaagttcatctgcaccaccggcaagctgcctgtgccctggcccaccctggtgaccaccctgagctacggcgtgcagtgcttctcacgctaccccgatcacatgaagcagcacgacttcttcaagagcgccatgcctgagggctacatccaggagcgcaccatcttcttcgaggatgacggcaactacaagtcgcgcgccgaggtgaagttcgagggcgataccctggtgaatcgcatcgagctgaccggcaccgatttcaaggaggatggcaacatcctgggcaataagatggagtacaactacaacgcccacaatgtgtacatcatgaccgacaaggccaagaatggcatcaaggtgaacttcaagatccgccacaacatcgaggatggcagcgtgcagctggccgaccactaccagcagaatacccccatcggcgatggccctgtgctgctgcccgataaccactacctgtccacccagagcgccctgtccaaggaccccaacgagaagcgcgatcacatgatctacttcggcttcgtgaccgccgccgccatcacccacggcatggatgagctgtacaagtccggactcagatctcatcaccatcaccatcactaa

SEQ ID NO: 8 - DNA, 2625 bp, Artificial
  polynucleotide sequence encoding fusion protein dsRed-MBP-acGFP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccgtgggctgggaggcctccaccgagcgcctgtacccccgcgacggcgtgctgaagggcgagacccacaaggccctgaagctgaaggacggcggccactacctggtggagttcaagtccatctacgcggccaagaagcccgtgcagctgcccggctactactacgtggacgccaagctggacatcacctcccacaacgaggactacaccatcgtggagcagtacgagcgcaccgagggccgccaccacctgttcctggcagcggccgcggctattgctaaaatcgaagaaggtaaactggtaatctggattaacggcddkddkggctataacggtctcgctgaagtcggtaagaaattcgagaaagataccggaattaaagtcaccgttgagcatccggataaactggaagagaaattcccacaggttgcggcaactggcgatggccctgacattatcttcddkgcacacddkddktttggtggctacgctcaatctggcctgttggctgaaatcaccccggacaaagcgttccaggacaagctgtatccgtttacctgggatgccgtacgttacaacggcaagctgattgcttacccgatcgctgttddkgcgttatcgctgatttataacaaagatctgctgccgaacccgccaaaaacctgggaagagatcccggcgctggataaagaactgaaagcgaaaggtaagagcgcgctgatgttcaacctgcaaddkccgddkttcacctggccgctgattgctgctgacgggggttatgcgttcaagtatgaaaacggcaagtacgacattaaagacgtgggcgtggataacgctggcgcgaaagcgggtctgaccttcctggttgacctgattaaaaacaaacacatgaatgcagacaccgattactccatcgcagaagctgcctttaataaaggcgaaacagcgatgaccatcaacggcccgtgggcatggtccaacatcgacaccagcaaagtgaattatggtgtaacggtactgccgaccttcaagggtcaaccatccaaaccgttcgttggcgtgctgagcgcaggtattaacgccgccagtccgaacaaagagctggcaaaagagttcctcgaaaactatctgctgactgatgaaggtctggaagcggttaataaagacaaaccgctgggtgccgtagcgctgaagtcttacgaggaagagttggcgaaagatccacgtattgccgccactatggaaaacgcccagaaaggtgaaatcatgccgaacatcccgcagatgtccgctttctggtatgccgtgcgtactgcggtgatcaacgccgccagcggtcgtcagactgtcgatgaagccctgaaagacgcgcagactaattcgagctcgaacaacaacaacaataacaataacaacaacctcgggatcgagggaagggtgtcagaattcgccaccgcggtgagcaagggcgccgagctgttcaccggcatcgtgcccatcctgatcgagctgaatggcgatgtgaatggccacaagttcagcgtgagcggcgagggcgagggcgatgccacctacggcaagctgaccctgaagttcatctgcaccaccggcaagctgcctgtgccctggcccaccctggtgaccaccctgagctacggcgtgcagtgcttctcacgctaccccgatcacatgaagcagcacgacttcttcaagagcgccatgcctgagggctacatccaggagcgcaccatcttcttcgaggatgacggcaactacaagtcgcgcgccgaggtgaagttcgagggcgataccctggtgaatcgcatcgagctgaccggcaccgatttcaaggaggatggcaacatcctgggcaataagatggagtacaactacaacgcccacaatgtgtacatcatgaccgacaaggccaagaatggcatcaaggtgaacttcaagatccgccacaacatcgaggatggcagcgtgcagctggccgaccactaccagcagaatacccccatcggcgatggccctgtgctgctgcccgataaccactacctgtccacccagagcgccctgtccaaggaccccaacgagaagcgcgatcacatgatctacttcggcttcgtgaccgccgccgccatcacccacggcatggatgagctgtacaagtccggactcagatctcatcaccatcaccatcactaa

SEQ ID NO: 9 - DNA, 1635 bp, Artificial
  polynucleotide sequence encoding fusion protein dsRed-GGBP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccatgggctgggaggcctccaccgagcgcctgtacccccgcgacggcgtgctgaagggcgagacccacaaggccctgaagctgaaggacggcggccactacctggtggagttcaagtccatctacatggccaagaagcccgtgcagctgcccggctactactacgtggacgccaagctggacatcacctcccacaacgaggactacaccatcgtggagcagtacgagcgcaccgagggccgccaccacctgttcctggcagcggccgctgatactcgcattggtgtaacaatcddkaagtacgacddkaacddkatgtctgtagtgcgcaaggctattgagcaagatgcgaaagccgcgccagatgttcagctgctgatgaatgattctcagaatgaccagtccaagcagaacgatcagatcgacgtattgctggccaagggggtgaaggcactggccatcaacctggttgacccggcagctgcgggtacggtgattgagaaagcgcgtgggcaaaacgtgccggtggttttcttcddkddkgaaccgtctcgtaaggcgctggatagctacgacaaagcctactacgttddkddkgacddkaaagagtccggcattattcaaggcgatttgattgctaaacactgggcggcgaatcagggttgggatctgaacaaagacggtcagattcagttcgtactgctgaaaggtgaaccgggcddkccgddkgcagaagcaddkaccacttacgtgattaaagaattgaacgataaaggcatcaaaactgaacagttacagttagataccgcaatgtgggacaccgctcaggcgaaagataagatggacgcctggctgtctggcccgaacgccaacaaaatcgaagtggttatcgccddkddkgatddkatggcaatgggcgcggttgaagcgctgaaagcacacaacaagtccagcattccggtgtttggcddkddkgcgddkccagaagcgctggcgctggtgaaatccggtgcactggcgggcaccgtactgddkgatgctaacaacddkgcgaaagcgacctttgatctggcgaaaaacctggccgatggtaaaggtgcggctgatggcaccaactggaaaatcgacaacaaagtggtccgcgtaccttatgttggcgtagataaagacaacctggctgaattcagcaagagatctcatcaccatcaccatcactaa

SEQ ID NO: 10 - DNA, 1815 bp, Artificial
  polynucleotide sequence encoding fusion protein dsRed-MBP
atggcctcctccgagaacgtcatcaccgagttcatgcgcttcaaggtgcgcatggagggcaccgtgaacggccacgagttcgagatcgagggcgagggcgagggccgcccctacgagggccacaacaccgtgaagctgaaggtgaccaagggcggccccctgcccttcgcctgggacatcctgtccccccagttccagtacggctccaaggtgtacgtgaagcaccccgccgacatccccgactacaagaagctgtccttccccgagggcttcaagtgggagcgcgtgatgaacttcgaggacggcggcgtggcgaccgtgacccaggactcctccctgcaggacggcgccttcatctacaaggtgaagttcatcggcgtgaacttcccctccgacggccccgtgatgcagaagaagaccgtgggctgggaggcctccaccgagcgcctgtacccccgcgacggcgtgctgaagggcgagacccacaaggccctgaagctgaaggacggcggccactacctggtggagttcaagtccatctacgcggccaagaagcccgtgcagctgcccggctactactacgtggacgccaagctggacatcacctcccacaacgaggactacaccatcgtggagcagtacgagcgcaccgagggccgccaccacctgttcctggcagcggccgcggctattgctaaaatcgaagaaggtaaactggtaatctggattaacggcddkddkggctataacggtctcgctgaagtcggtaagaaattcgagaaagataccggaattaaagtcaccgttgagcatccggataaactggaagagaaattcccacaggttgcggcaactggcgatggccctgacattatcttcddkgcacacddkddktttggtggctacgctcaatctggcctgttggctgaaatcaccccggacaaagcgttccaggacaagctgtatccgtttacctgggatgccgtacgttacaacggcaagctgattgcttacccgatcgctgttddkgcgttatcgctgatttataacaaagatctgctgccgaacccgccaaaaacctgggaagagatcccggcgctggataaagaactgaaagcgaaaggtaagagcgcgctgatgttcaacctgcaaddkccgddkttcacctggccgctgattgctgctgacgggggttatgcgttcaagtatgaaaacggcaagtacgacattaaagacgtgggcgtggataacgctggcgcgaaagcgggtctgaccttcctggttgacctgattaaaaacaaacacatgaatgcagacaccgattactccatcgcagaagctgcctttaataaaggcgaaacagcgatgaccatcaacggcccgtgggcatggtccaacatcgacaccagcaaagtgaattatggtgtaacggtactgccgaccttcaagggtcaaccatccaaaccgttcgttggcgtgctgagcgcaggtattaacgccgccagtccgaacaaagagctggcaaaagagttcctcgaaaactatctgctgactgatgaaggtctggaagcggttaataaagacaaaccgctgggtgccgtagcgctgaagtcttacgaggaagagttggcgaaagatccacgtattgccgccactatggaaaacgcccagaaaggtgaaatcatgccgaacatcccgcagatgtccgctttctggtatgccgtgcgtactgcggtgatcaacgccgccagcggtcgtcagactgtcgatgaagccctgaaagacgcgcagactcatcaccatcaccatcactaa

SEQ ID NO: 11 - DNA, 1635 bp, Artificial; identical to SEQ ID NO: 3
  polynucleotide sequence encoding fusion protein dsRed-GGBP

SEQ ID NO: 12 - DNA, 1815 bp, Artificial; identical to SEQ ID NO: 4
  polynucleotide sequence encoding fusion protein dsRed-MBP